(19) United States
(12) Patent Application Publication
(10) Pub. No.: US 2013/0162375 A1
(43) Pub. Date: Jun. 27, 2013

(54) METHOD FOR PRODUCING METAMATERIAL AND METAMATERIAL

(71) Applicant: Asahi Glass Company, Limited, Tokyo (JP)

(72) Inventors: Kenji KITAOKA, Tokyo (JP); Kazuhiko Niwano, Tokyo (JP)

(73) Assignee: Asahi Glass Company, Limited, Tokyo (JP)

(21) Appl. No.: 13/722,583

(22) Filed: Dec. 20, 2012

(30) Foreign Application Priority Data
Dec. 26, 2011 (JP) 2011-284087

(51) Int. Cl. H01P 7/00

(52) U.S. Cl. CPC H01P 7/00; Y10S 977/734; B82Y 30/00
USPC 333/219; 427/248.1; 427/249.1; 427/58; 156/60; 430/320; 977/734

(57) ABSTRACT

A method for producing a metamaterial including an electromagnetic wave resonator resonating with an electromagnetic wave. The method includes the steps of: (a) forming a support by a nanoimprint method or a photolithography method, the support including a portion on which an electromagnetic wave resonator is to be formed; and (b) vapor-depositing a material which can form the electromagnetic wave resonator on the portion of the support to thereby arrange the electromagnetic wave resonator on the support.

### BACKGROUND OF THE INVENTION

1. Technical Field

The present invention relates to a method for producing a metamaterial and a metamaterial.

2. Background Art

Hitherto various technologies relating to a method for producing a metamaterial and a metamaterial have been disclosed.

For example, Patent Document 1 discloses a metamaterial including a plurality of at least either electric resonators or magnetic resonators smaller than a wavelength of light wave, which is arranged within only a predetermined plane. Patent Document 2 discloses a method for producing an anisotropic film, including a step of foaming a metal nanostructure on a base material, a step of forming a resin film having the metal nanostructure embedded therein, and a step of peeling the resin film from the base material, wherein the step of forming a metal nanostructure on the base material includes at least a step of forming a coating film including a metal layer formed by electroless plating on a surface of a template arranged on the base material, and a step of removing a part or the whole of the template while leaving a part or the whole of the coating film.
Patent Document 1: JP-A-2006-350232
Patent Document 2: JP-A-2009-057518

### SUMMARY OF THE INVENTION

The conventional general method for producing a metamaterial uses lithography technology and etching technology in producing an electromagnetic wave resonator. However, those methods may cause variations in shape, dimension and the like of the electromagnetic wave resonator particularly due to utilization of etching technology in the case of, for example, mass-producing a metamaterial having fine electromagnetic wave resonators. For this reason, it is believed that the conventional method is possible to produce a metamaterial in a laboratory level, but is difficult to mass-produce a metal material efficiently (with good yield).

The present invention has been made in view of the above background. An object of the present invention is to provide a method capable of producing a metamaterial more efficiently.

The present invention provides the following method for producing a metamaterial and metamaterial.

(1) A method for producing a metamaterial comprising an electromagnetic wave resonator resonating with an electromagnetic wave, the method comprising the steps of:

(a) forming a support by a nanoimprint method or a photolithography method, the support comprising a portion on which an electromagnetic wave resonator is to be formed, and

(b) vapor-depositing a material which can form the electromagnetic wave resonator on the portion of the support to thereby arrange the electromagnetic wave resonator on the support.

(2) The method according to (1), wherein the step (b) comprises vapor-depositing the material which can form the electromagnetic wave resonator on the portion of the support by a physical vapor deposition.

(3) The method according to (1) or (2), wherein the portion has one or two or more convex portions.

(4) The method according to (3), wherein the convex portion comprises a projection having an upper part and a side part, or side parts, and the upper part has a single flat surface, a plurality of surfaces having a difference in level, or a curved surface having a top.

(5) The method according to (4), wherein the step (b) comprises vapor-depositing the material which can form the electromagnetic wave resonator to the upper part of the projection and at least a part of the side part of the projection by vapor-depositing the material which can form the electromagnetic wave resonator to the portion of the support from a first direction.

(6) The method according to any one of (1) to (5), wherein the step (b) comprises vapor-depositing the material which can form the electromagnetic wave resonator to the portion of the support from two or more different directions.

(7) The method according to any one of (1) to (6), wherein the electromagnetic wave resonator is vapor-deposited to the portion in an approximate inverted U-shape upon viewing the support from a side direction thereof, and is vapor-deposited to the portion in an approximate C-shape upon viewing the support from a thickness direction thereof.

(8) The method according to any one of (1) to (7), wherein the material which can form the electromagnetic wave resonator is not vapor-deposited to a portion other than the portion of the support.

(9) The method according to any one of (1) to (8), wherein the support is composed of a material permeable to the electromagnetic wave.

(10) The method according to (9), wherein the material which can form the electromagnetic wave resonator is at least one selected from the group consisting of graphene, indium-tin oxide, zinc oxide and tin oxide.

(11) The method according to any one of (1) to (10), wherein the step (b) comprises the steps of:

(b1) vapor-depositing a first dielectric to the portion of the support, and

(b2) vapor-depositing a conductive material and/or a second dielectric on the first dielectric after the step (b1).

(12) The method according to any one of (1) to (10), wherein the step (b) comprises the steps of:

(b3) vapor-depositing a metal film to the portion of the support, and

(b4) vapor-depositing a graphene film on the metal film.

(13) The method according to (12), wherein the step (b) further comprises the steps of:

(b5) integrating the support having the graphene film with a second support such that a side of the graphene film faces inside, and

(b6) selectively removing the support and the metal film, thereby obtaining the second support having the graphene film.

(14) The method according to any one of (1) to (10), further comprising the steps of:

(c) selectively dissolving the support in a liquid, and

(d) forming a metamaterial in a state that the electromagnetic wave resonator is dispersed in a dielectric matrix.

(15) The method according to any one of (1) to (10), further comprising the step of:

(e) transferring the electromagnetic wave resonator arranged on the support to a material having adhesiveness.

(16) The method according to any one of (15), further comprising the step of:

(f) laminating the material having adhesiveness, which has the electromagnetic wave resonators transferred thereto, such that the electromagnetic wave resonators are piled up in a lamination direction.

(17) A metamaterial comprising a support having a plurality of convex portions, and an electromagnetic wave resonator which resonates with an electromagnetic wave and is arranged on each convex portion,

wherein the each convex portion comprises a projection having an upper part and a side part, or side parts,

the upper part has a single flat surface, a plurality of surfaces having a difference in level, or a curved surface having a top,

a material which can form the electromagnetic wave resonator is vapor-deposited to the upper part of the projection and at least a part of the side part of the projection,

the electromagnetic wave resonator is formed in an approximate inverted U-shape having two end parts on each projection upon viewing the support from a side direction, and

a length from the upper part to one end part of the two end parts in a height direction is different from a length from the upper part to the other end part of the two end parts in the height direction.

(18) A metamaterial comprising a support having a plurality of convex portions, and an electromagnetic wave resonator which resonates with an electromagnetic wave and is arranged on each convex portion,

wherein the each convex portion comprises a projection having an upper part and a side part, or side parts,

the upper part has a single flat surface, a plurality of surfaces having a difference in level, or a curved surface having a top,

a material which can form the electromagnetic wave resonator is vapor-deposited to the upper part of the projection and at least a part of the side part of the projection,

each projection constituting the plurality of convex portions is formed such that a cross-section of the projection in a horizontal direction has an approximate C-shape, and the each projection has an upper part in an approximate C-shape and a side part in an approximate prism shape,

the electromagnetic wave resonator is formed on the upper part of the projection and at least a part of the side part of the projection, and

a dimension in a height direction of the electromagnetic wave resonator differs between one surface of the side part and a surface opposite to the surface.

(19) A metamaterial comprising a support having a plurality of convex portions, and an electromagnetic wave resonator which resonates with an electromagnetic wave and is arranged on each convex portion,

wherein the each convex portion comprises a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

at least two projections have a similarity shape each other, and

the respective electromagnetic wave resonators arranged on the at least two projections have substantially different dimensions while maintaining the similarity shape.

(20) The metamaterial according to any of (17) to (19), wherein the electromagnetic wave resonator is not formed on a portion other than the projection of the support.

(21) A metamaterial comprising a support having a plurality of concave portions, and an electromagnetic wave resonator which resonates with an electromagnetic wave and is arranged on the concave portion,

wherein the concave portion comprises a depression having a bottom part and a side part, or side parts,

the bottom part has a single flat surface, a plurality of surfaces having a difference in level, or a curved surface having a top,

the material which can form the electromagnetic wave resonator is vapor-deposited to the bottom part of the depression and at least a part of the side part of the depression,

the electromagnetic wave resonator is formed in an approximate U-shape having two end parts on each depression upon viewing the support from a side direction, and

a length from the bottom part to one end part of the two end parts in a height direction is different from a length from the bottom part to the other end part of the two end parts in the height direction.

(22) A metamaterial comprising a support having a plurality of concave portions, and an electromagnetic wave resonator which resonates with an electromagnetic wave and is arranged on the concave portion,

wherein the concave portion comprises a depression having a bottom part and a side part, or side parts,

the bottom part has a single flat surface, a plurality of surfaces having a difference in level, or a curved surface having a top,

the material which can form the electromagnetic wave resonator is vapor-deposited to the bottom part of the depression and at least a part of the side part of the depression,

at least two depressions have similarity shape each other, and

the respective electromagnetic wave resonators arranged on the at least two depressions have substantially different dimensions while maintaining the similarity shape.

(23) The metamaterial according to (21) or (22), wherein the electromagnetic wave resonator is not formed on a portion other than the depression of the support.

(24) The metamaterial according to any one of (21) to (23), wherein the electromagnetic wave resonator is composed of a conductive substance through which an electromagnetic wave in a visible band transmits.

(25) The metamaterial according to (24), wherein the electromagnetic wave resonator is at lest one selected from the group consisting of graphene, indium-tin oxide, zinc oxide and tin oxide.

The present invention can provide a method that is capable of producing a metamaterial more efficiently as compared with the conventional methods.

### BRIEF DESCRIPTION OF THE DRAWINGS

FIGS. 1(a) and (b) are views explaining a method for producing a metamaterial according to a first embodiment of the present invention.

FIGS. 2(a) to (c) are views explaining a method for evaluating properties of resonance of an electromagnetic wave resonator to an electromagnetic wave having a certain specific frequency.

FIGS. 3(a) and (b) are views explaining a method for producing a metamaterial according to a second embodiment of the present invention.

FIG. 4 is a view explaining a method for producing a metamaterial according to a third embodiment of the present invention.

FIGS. 5(a) and (b) are views explaining a method for producing a metamaterial according to a fourth embodiment of the present invention.

FIGS. 6(a) to (d) are views explaining a method for producing a metamaterial according to a fifth embodiment of the present invention.

FIGS. 7(a) to (e) are views explaining a method for producing a metamaterial according to a sixth embodiment of the present invention.

FIG. 8 is a view explaining an example of a metamaterial produced according to the embodiment of the present invention.

FIG. 9 is a transmission electron microscope photograph showing a cross-sectional shape of a metamaterial produced by a sixth embodiment of the present invention.

FIG. 10 is a view showing absorbance measurement results of a metamaterial produced according to a sixth embodiment of the present invention.

FIG. 11 is a view showing spectral transmission measurement results of a metamaterial produced according to a sixth embodiment of the present invention.

FIG. 12 is a view explaining oblique vapor deposition in the method for producing a metamaterial according to a sixth embodiment of the present invention.

FIGS. 13(a) to (c) are views explaining a unit cell of electromagnetic field analytical model of a metamaterial according to a sixth embodiment of the present invention.

FIG. 14 is a view explaining electromagnetic field analytical results of a metamaterial according to a sixth embodiment of the present invention.

FIGS. 15(a) to (d) are views explaining frequency dependency of permittivity and permeability of electromagnetic wave resonators having different height, width and/or depth according to the embodiments of the present invention.

FIG. 16(a) to (b) are a view schematically showing a pattern of a mold used in Example 2.

FIG. 17 is a cross-sectional view schematically showing a pattern of pillar projections formed on a quartz glass substrate in Example 2.

### DETAILED DESCRIPTION OF THE INVENTION

The constitution of the present invention is described below.

The present invention provides a method for producing a metamaterial including an electromagnetic wave resonator resonating with an electromagnetic wave, the method including the steps of:

(a) forming a support by a nanoimprint method or a photolithography method, the support including a portion on which an electromagnetic wave resonator is to be formed, and

(b) vapor-depositing a material which can form the electromagnetic wave resonator to the portion of the support to thereby arrange the electromagnetic wave resonator on the support.

The conventional general method for producing a metamaterial uses lithography technology and etching technology in producing an electromagnetic wave resonator. However, the method may cause variations in dimension, shape and the like of the electromagnetic wave resonator particularly due to utilization of etching technology in the case of, for example, mass-producing a metamaterial having a fine electromagnetic wave resonator. For this reason, it is believed that the conventional method is difficult to efficiently mass-produce a metal material.

On the other hand, in the present invention, the electromagnetic wave resonator is formed and arranged on a support by a vapor deposition method. The vapor deposition method can form a film of an electromagnetic wave resonator having desired characteristics on a desired position with good reproducibility. In other words, the present invention does not use etching technology that is easy to cause variations, in forming an electromagnetic wave resonator. For this reason, the method for producing a metamaterial according to the present invention can produce a metamaterial more efficiently.

In the method for producing a metamaterial according to the present invention, vapor deposition is preferably conducted from two or more different directions in vapor-depositing a material which can form an electromagnetic wave resonator. This can easily form and arrange an asymmetrical electromagnetic wave resonator on the portion of the support. Furthermore, by conducting the vapor deposition from an oblique direction to the support, not a direction parallel to a thickness direction to the support, a material which can form the electromagnetic wave resonator can be suppressed from being film-formed on a portion other than the portion to which an electromagnetic wave resonator is to be formed, of the support.

The portion of the support to which an electromagnetic wave resonator is to be vapor-deposited may have one or more convex portions. The convex portion is constituted as a projection having an upper part and a side part, or side parts, and the upper part may have a single flat surface, a plurality of surfaces having a difference in level, or a curved surface having a top.

The metamaterial obtained through the step (b) may directly be used, but may be used in other form by further conducting the following steps.

For example, in the case where the following steps are carried out, a metamaterial having electromagnetic wave resonators randomly dispersed in a matrix can be obtained:

(c) a step of selectively dissolving the support having the electromagnetic wave resonators in a liquid; and

(d) a step of dispersing the residual electromagnetic wave resonators in a liquid that becomes a transparent dielectric later, and solidifying the liquid, thereby dispersing the electromagnetic wave resonators in a dielectric matrix.

Alternatively, the following steps may be carried out:

(e) a step of transferring the electromagnetic wave resonators arranged on the support to a material having adhesiveness; and if necessary, in addition to this step,

(f) a step of laminating the material having adhesiveness, which has the electromagnetic wave resonators transferred thereto, such that the electromagnetic wave resonators are piled up in a lamination direction.

By transferring the electromagnetic wave resonators to the material having adhesiveness, the electromagnetic wave resonators can be supplied in a necessary form later. Furthermore, by laminating the material having adhesiveness, for example, a device having a thickness, such as a lens, can be manufactured.

A metal is generally used as the material which can form the electromagnetic wave resonator. However, the metal sometimes absorbs an electromagnetic wave in a visible light region. Therefore, in an application example of a metamaterial requiring permeability in a visible light region, low resistance carbon such as grapheme and oxide-based transparent conductive materials such as ITO (indium-tin oxide), ZnO (zinc oxide) and SnO₂ (tin oxide) may be used as the material which can form the electromagnetic wave resonator. Alternatively, materials having resonance frequency equal to or lower than infrared region may be used.

Thus, absorption of an electromagnetic wave in a visible light region is suppressed, and a metamaterial having high permeability can be provided.

The present invention further provides a metamaterial having the following structures.

(i) A metamaterial including a support having a plurality of convex portions, and an electromagnetic wave resonator which resonates with an electromagnetic wave and is arranged on each convex portion,

wherein the each convex portion includes a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

the electromagnetic wave resonator is formed in an approximate inverted U-shape having two end parts on each projection when viewing the support from a side direction, and

a length from the upper part to one end part of the two end parts in a height direction is different from a length from the upper part to the other end part of the two end parts in the height direction.

(ii) A metamaterial including a support having a plurality of convex portions, and an electromagnetic wave resonator which resonates with an electromagnetic wave and is arranged on each convex portion,

wherein the each convex portion includes a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

each projection constituting the plurality of convex portions is formed such that a cross-section in a horizontal direction has an approximate C-shape, and the each projection has an upper part in an approximate C-shape and a side part in an approximate prism shape,

the electromagnetic wave resonator is formed on the upper part of the projection and at least a part of the side part of the projection, and

a dimension in a height direction of the electromagnetic wave resonator differs between one surface of the side and a surface opposite to the surface.

(iii) A metamaterial including a support having a plurality of convex portions, and an electromagnetic wave resonator which resonates with an electromagnetic wave and is arranged on each convex portion,

wherein the each convex portion includes a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

at least two projections have a similarity shape each other, and

the respective electromagnetic wave resonators arranged on the at least two projections have substantially different dimensions while maintaining the similarity shape.

(iv) A metamaterial including a support having a plurality of concave portions, and an electromagnetic wave resonator which resonates with an electromagnetic wave and is arranged on the concave portion,

wherein the concave portion includes a depression having a bottom part and a side part, or side parts,

the bottom part has a single flat surface, a plurality of surfaces having a difference in level, or a curved surface having a top,

the material which can form the electromagnetic wave resonator is vapor-deposited and placed by, for example, printing, to the bottom of the depression and at least a part of the side part of the depression,

the electromagnetic wave resonator is formed in an approximate U-shape having two end parts on each depression when viewing the support from a side direction, and

a length from the bottom part to one end part of the two end parts in a height direction is different from a length from the bottom part to the other end part of the two end parts in the height direction.

(v) A metamaterial including a support having a plurality of concave portions, and an electromagnetic wave resonator which resonates with an electromagnetic wave and is arranged on the concave portion,

wherein the concave portion includes a depression having a bottom part and a side part, or side parts,

the bottom part has a single flat surface, a plurality of surfaces having a difference in level, or a curved surface having a top,

the material which can form the electromagnetic wave resonator is vapor-deposited and placed by, for example, printing, to the bottom part of the depression and at least a part of the side part of the depression,

at least two depressions have similarity shape each other, and

the respective electromagnetic wave resonators arranged on the at least two depressions have substantially different dimensions while maintaining the similarity shape.

In the metamaterial shown in the above (i), when viewing the support from a side direction, the electromagnetic wave resonator is formed so as to have an approximate inverted U-shape having two end parts on each projection, and such that length of each end parts differs (i.e. a length from the upper part to one end part of the two end parts in a height direction is different from a length from the upper part to the other end part of the two end parts in the height direction).

In the metamaterial shown in the above (ii), each projection is constituted such that a cross-section in a horizontal direction has an approximate C-shape, that is, each projection has an upper part in an approximate C-shape and a side part in an approximate prism shape, and the electromagnetic wave resonator is formed on the upper part of the projection and at least a part of the side part of the projection. In this case, the electromagnetic wave resonator is formed such that a dimension in a height direction of the electromagnetic wave resonator differs between one surface of the side part of the projection and a surface opposite to the surface.

In the metamaterial shown in the above (iv), when viewing the support from a side direction, the electromagnetic wave resonator is formed such that the electromagnetic wave resonator has an approximate U-shape having two end parts, and length of each end part differs (i.e. a length from the bottom part to one end part of the two end parts in a height direction is different from a length from the bottom part to the other end part of the two end parts in the height direction).

The combination (assembly) of the electromagnetic wave resonator and the support develops negative refractive index characteristics in a specific frequency region as described in detail hereinafter due to the asymmetric shape of each electromagnetic wave resonator. Therefore, the assembly can develop a function of a metamaterial as a left-handed medium.

In the metamaterial shown in the above (iii), at least two projections have similarity shape each other, and the electromagnetic wave resonator is formed on those two projections. In this case, an electromagnetic resonator in which the two projections have substantially different dimensions and have similarity shape is obtained.

In the metamaterial shown in the above (v), at least two depressions have similarity shape each other, and the electromagnetic wave resonator is formed on the two depressions. In this case, an electromagnetic wave resonator in which the two depressions have substantially different dimensions and have similarity shape is obtained.

Even in the assemblies of the electromagnetic wave resonator and the support as shown in the above (iii) and (v), negative refractive index characteristics are developed in a specific frequency region as described in detail hereinafter due to the difference in dimension of a plurality of electromagnetic wave resonators. Therefore, the assemblies can develop a function of a metamaterial as a left-handed medium.

### First Embodiment

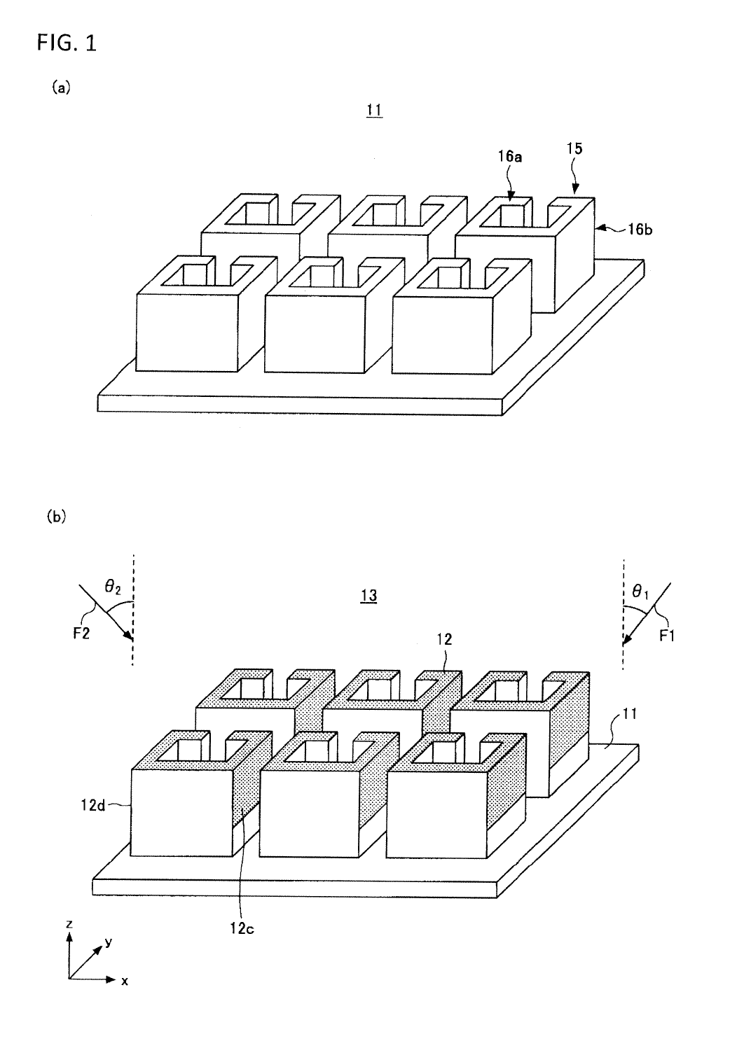

FIG. 1(a) and FIG. 1(b) show a view explaining a method for producing a metamaterial according to a first embodiment of the present invention. FIG. 1(a) is a view explaining a support in the method for producing a metamaterial according to the first embodiment of the present invention. FIG. 1(b) is a view explaining a metamaterial in the method for producing a metamaterial according to the first embodiment of the present invention.

As shown in FIG. 1(a), in the method for producing a metamaterial according to the first embodiment of the present invention, a support 11 for supporting an electromagnetic wave resonator resonating with an electromagnetic wave (hereinafter simply referred to as an “electromagnetic wave resonator”) is prepared.

The method for preparing the support 11 is not particularly limited, and the support 11 may be prepared using a photolithography method or a nanoimprint method.

The nanoimprint method has, for example, the following steps: (1) a step of providing a layer of a photocurable resin on a substrate, (2) a step of pressing a mold having a certain pattern to the layer of a photocurable resin, (3) a step of curing the photocurable resin in the state of pressing the mold to the layer of the photocurable resin, and (4) a step of obtaining a substrate having the cured resin having the pattern of the mold transferred thereto, that is, the support 11, by removing the mold from the cured resin.

The support 11 has a shape corresponding to the shape of the electromagnetic wave resonator contained in the metamaterial. The shape of the support 11 corresponding to the shape of the electromagnetic wave resonator is a shape such that, when a material of the electromagnetic wave resonator is vapor-deposited to the support 11, the electromagnetic wave resonator formed by the vapor deposition resonates with an electromagnetic wave.

For example, in the example of FIG. 1(a), the support 11 has a plurality of projections 15 such that a cross-section in a horizontal direction has an approximate C-shape. In other words, each projection 15 is constituted so as to have an upper part 16a in an approximate C-shape and a side part 16b in an approximate quadrangular prism shape having a hollowed inside. It should be noted that a part of the side part 16b is removed in a slit form from the bottom surface to the upper surface along a height direction. The projection 15 as shown in FIG. 1(a) may be hereinafter simply referred to as a “C-shaped projection 15”. The shape of the electromagnetic wave resonator formed on the projection 15 may be particularly referred to as a “C-shaped electromagnetic wave resonator”.

The shape of the projection 15 of the support 11 shown in FIG. 1(a) is one example, and the projection may have other shapes. For example, the side surface of the C-shaped projection 15 may have forms other than an approximate quadrangular prism, such as an approximate triangular prism, an approximate pentagonal prism and an approximate cylinder.

Alternatively, the projection of the support 11 has an upper part and a side part, and the upper part may have a shape such as a single flat surface, a plurality of surfaces having a difference in level, or a curved surface having a top. For example, in the case where the upper part of the projection has a shape such as a curved surface having a top, the shape of the electromagnetic wave resonator formed thereon is an approximate “inverted U-shape”.

A material of the support 11 is not particularly limited. When the support 11 is prepared by a nanoimprint method, the support is preferably composed of a resin obtained by curing a photocurable resin. Examples of the resin include resins described in, for example, WO2006/114958, JP-A-2009-073873 and JPA-2009-019174, the subject matters of which are herein incorporated by reference.

In the method for producing a metamaterial according to the first embodiment of the present invention, the material of the support 11 is preferably a material permeable to an electromagnetic wave of resonant frequency of an electromagnetic wave resonator. Examples of the material include a moldable ultraviolet-curing resin, a thermosetting resin and the like, and an acryl resin and a fluorine resin can be exemplified. Furthermore, a glass that can be subjected to transfer molding, silicon that can be subjected to fine processing by dry etching, ceramics to which a shape can be imparted by cast molding, and the like can be used as the support.

In this case, the metamaterial itself containing the support 11 and the electromagnetic wave resonator can be used as a functional element such an optical element without recovering the electromagnetic wave resonator from the support 11.

In the method for producing a metamaterial according to the first embodiment of the present invention, the support 11 is preferably composed of a resin. In this case, the support 11 having a shape corresponding to the shape of the electromagnetic wave resonator contained in the metamaterial can be easily prepared.

In the method for producing a metamaterial according to the first embodiment of the present invention, the resin constituting the support 11 is preferably a thermoplastic resin. In this case, the support 11 can be softened or melted more easily by heating the metamaterial. For this reason, the electromagnetic wave resonator can easily be recovered from the support 11.

In the method for producing a metamaterial according to the first embodiment of the present invention, the resin constituting the support 11 preferably contains a fluorine resin. The support 11 may be composed of a fluorine resin. Furthermore, the support 11 may be a support which is covered with a fluorine resin on a side to which a material of the electromagnetic wave resonator is vapor-deposited.

In this case, the support 11 contains a fluorine resin having higher hydrophobicity. Therefore, an electromagnetic wave resonator such as a conductive material or a dielectric can easily be recovered from the support 11.

As shown in FIG. 1(b), in the method for producing a metamaterial according to the first embodiment of the present invention, a material of the electromagnetic wave resonator 12 is vapor-deposited to the support 11 having a shape corresponding to the shape of the electromagnetic wave resonators 12. Thus, the electromagnetic wave resonators 12 are provided on the support 11. As a result, a metamaterial 13 containing the support 11 and the electromagnetic wave resonators 12 can be produced.

When a material of the electromagnetic wave resonators 12 is vapor-deposited to the C-shaped projection 15, the vapor deposition is preferably conducted such that a dimension of a vapor deposition region differs between a side surface of the C-shaped projection 15 and a side surface facing the C-shaped projection 15.

For example, in the case of FIG. 1(b), a material for the electromagnetic wave resonators 12 is vapor-deposited to the upper part 16a of the C-shaped projection 15 and a part of the side part 16b thereof in FIG. 1(a). Although not clear from FIG. 1(b), in this case, a material for the electromagnetic wave resonators 12 is vapor-deposited such that a dimension in a height direction of the electromagnetic wave resonators 12 differs between one side 12c of the electromagnetic wave resonators 12 and a side 12d opposite to the side 12c. By conducting the vapor-deposition like this, the “C-shaped electromagnetic wave resonator” 12 in which a dimension of vapor deposition area differs in side surfaces facing each other is formed.

The “C-shaped electromagnetic wave resonator” 12 in which a dimension of vapor deposition area differs in side surfaces facing each other can be formed by conducting vapor deposition from, for example, different two directions.

For example, in the example of FIG. 1(b), first vapor deposition is carried out from a direction of an arrow F1 shown in FIG. 1(b), and second vapor deposition is carried out from a direction of an arrow F2 shown in FIG. 1(b). Alternatively, the vapor deposition is carried out in the reverse order. Thus, the “C-shaped electromagnetic wave resonator” 12 in which a dimension of vapor deposition area differs in side surfaces facing each other can be obtained.

It should be noted in FIG. 1(b) that the arrow F1 and the arrow F2 are reverse mutually to a vertical axis (Z axis) and are present within the same plane (XZ plane) vertical to the surface of the support 11, but gradient (angle θ₁) of the arrow F1 is smaller than gradient (angle θ₂) of the arrow F2.

In other words, in this case, in the vapor deposition from the side of the arrow F2, the tendency that the projection of the upstream side shadows the projection of the downstream side is increased in the adjacent C-shaped projections 15. Therefore, the length of the electromagnetic wave resonators 12 in the side surface 12d can be shortened as compared with the length of the electromagnetic wave resonator 12 in the side surface 12c.

In the method for producing a metamaterial according to the first embodiment of the present invention, the electromagnetic wave may be any of an electromagnetic wave in a wavelength region of radio wave (electromagnetic wave having a wavelength exceeding 10 mm), an electromagnetic wave in millimeter wave and terahertz wave (electromagnetic wave having a wavelength exceeding 100 μm, and of 10 mm or less), an electromagnetic wave in a wavelength region of infrared light (electromagnetic wave having a wavelength exceeding 780 nm, and of 100 μm or less), an electromagnetic wave in a wavelength region of visible light (electromagnetic wave having a wavelength exceeding 380 nm, and of 780 nm or less), and an electromagnetic wave having a wavelength of an ultraviolet (electromagnetic wave having a wavelength exceeding 10 nm, and 380 nm or less) in a wavelength region of ultraviolet light.

The electromagnetic wave resonators 12 have a shape constituting a kind of LC circuit. As shown in FIG. 1(b), in the method for producing a metamaterial according to the first embodiment of the present invention, the shape of the electromagnetic wave resonators 12 is a “C-shape” or an “inverted U-shape”. Thus, the shape of the electromagnetic wave resonators 12 has surfaces facing each other through a gap such that the electromagnetic wave resonators 12 have capacitance.

For example, in the case where the electromagnetic wave resonators 12 shown in FIG. 1(b) have an “inverted U-shape”, the “U-shaped electromagnetic wave resonators 12” have a gap between both end parts thereof. The shape of the electromagnetic wave resonators 12 has a structure capable of forming a loop by conduction current and displacement current such that the electromagnetic wave resonators 12 have inductance. The electromagnetic wave resonators 12 shown in FIG. 1(b) have the structure capable of forming a loop by conduction current flowing from one end part of the “inverted U-shape” to the other end part thereof and displacement current generated in a gap between both end parts of the “inverted U-shape”.

The electromagnetic wave resonators 12 shown in FIG. 1(b) have a “C-shape” or an “inverted U-shape” (Split Ring Resonator (SRR)), but an electromagnetic wave resonator having a shape of a combination of two U-shaped parts each having an opening at a side opposite each other, as disclosed in, for example, JP-A-2006-350232 may be used as an electromagnetic wave resonator having other shape.

The “C-shaped” or “inverted U-shaped” electromagnetic wave resonator causes magnetic resonance and electric resonance with increasing a frequency, and permeability and permittivity show a negative value in a high frequency band just after the respective resonance frequencies. In this case, in the case where the electromagnetic wave resonator has a symmetrical shape, the frequency that permittivity and permeability show a negative value respectively differs.

However, the present inventors have found that in the case of an “inverted U-shape” as the embodiment that the electromagnetic wave resonator is SRR, of two end parts of the “inverted U-shaped electromagnetic wave resonator”, when the length of one end part is longer than that of the other end part, thus making asymmetric, both permittivity and permeability show negative values in a specific frequency band, and negative refractive index can be realized.

In other words, by making the length of the end part at one side of the “inverted U-shaped” electromagnetic wave resonator longer than that of the end part at the other side thereof, frequency of electric resonance can be shifted to low frequency. Therefore, by adjusting the length of the end part at one side thereof, both permeability and permittivity can have negative values in the same frequency band, and negative refractive index can be realized at the same frequency band.

Similarly, in the case of the “C-shape”, of the two parts facing each other in side surfaces of the “C-shaped electromagnetic wave resonator”, when the length of one side is longer than that of the other side, thus making asymmetric, both permittivity and permeability show negative values in a specific frequency band, and negative refractive index can be realized.

It has been found in other embodiment that by arranging a plurality of supports having different height, width and/or depth by nanoimprint and changing height, width and/or depth of the electromagnetic wave resonators, the refractive index in a certain frequency band can be made negative.

In other words, the metamaterial in the present invention has the following characteristics.

(i) A metamaterial including a support having a plurality of convex portions, and an electromagnetic wave resonator which resonates with an electromagnetic wave and is arranged on each convex portion,

wherein the each convex portion includes a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

the electromagnetic wave resonator is formed in an approximate inverted U-shape having two end parts on each projection when viewing the support from a side direction, and

a length from the upper part to one end part of the two end parts in a height direction is different from a length from the upper part to the other end part of the two end parts in the height direction.

(ii) A metamaterial including a support having a plurality of convex portions, and an electromagnetic wave resonator which resonates with an electromagnetic wave and is arranged on each convex portion,

wherein the each convex portion includes a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

each projection constituting the plurality of convex portions is formed such that a cross-section in a horizontal direction has an approximate C-shape, and the each projection has an upper part in an approximate C-shape and a side part in an approximate prism shape,

the electromagnetic wave resonator is formed on the upper part of the projection and at least a part of the side part of the projection, and

a dimension in a height direction of the electromagnetic wave resonator differs between one surface of the side and a surface opposite to the surface.

(iii) A metamaterial including a support having a plurality of convex portions, and an electromagnetic wave resonator which resonates with an electromagnetic wave and is arranged on each convex portion,

wherein the each convex portion includes a projection having an upper part and a side part, or side parts,

the upper part has a single flat surface, a plurality of surfaces having a difference in level, or a curved surface having a top,

the material which can form the electromagnetic wave resonator is vapor-deposited to the upper part of the projection and at least a part of the side part of the projection,

at least two projections have a similarity shape each other, and

the respective electromagnetic wave resonators arranged on the at least two projections have substantially different dimensions while maintaining the similarity shape.

(iv) A metamaterial including a support having a plurality of concave portions, and an electromagnetic wave resonator which resonates with an electromagnetic wave and is arranged on the concave portion,

wherein the concave portion includes a depression having a bottom part and a side part, or side parts,

the bottom part has a single flat surface, a plurality of surfaces having a difference in level, or a curved surface having a top,

the material which can form the electromagnetic wave resonator is vapor-deposited to the bottom of the depression and at least a part of the side part of the depression,

the electromagnetic wave resonator is formed in an approximate U-shape having two end parts on each depression when viewing the support from a side direction, and

a length from the bottom part to one end part of the two end parts in a height direction is different from a length from the bottom part to the other end part of the two end parts in the height direction.

(v) A metamaterial including a support having a plurality of concave portions, and an electromagnetic wave resonator which resonates with an electromagnetic wave and is arranged on the concave portion,

wherein the concave portion includes a depression having a bottom part and a side part, or side parts,

the bottom part has a single flat surface, a plurality of surfaces having a difference in level, or a curved surface having a top,

the material which can form the electromagnetic wave resonator is vapor-deposited to the bottom part of the depression and at least a part of the side part of the depression,

at least two depressions have similarity shape each other, and

the respective electromagnetic wave resonators arranged on the at least two depressions have substantially different dimensions while maintaining the similarity shape.

In the metamaterials of the above (i) and (iv), the term that “a length from the upper/bottom part to one end part of the two end parts in a height direction is different from a length from the upper/bottom part to the other end part of the two end parts in the height direction” means that the length from the top of the inverted U-shape or U-shape to one end part of the two end parts in a height direction is different from the length from the top of the inverted U-shape or U-shape to the other end part of the two end parts in the height direction.

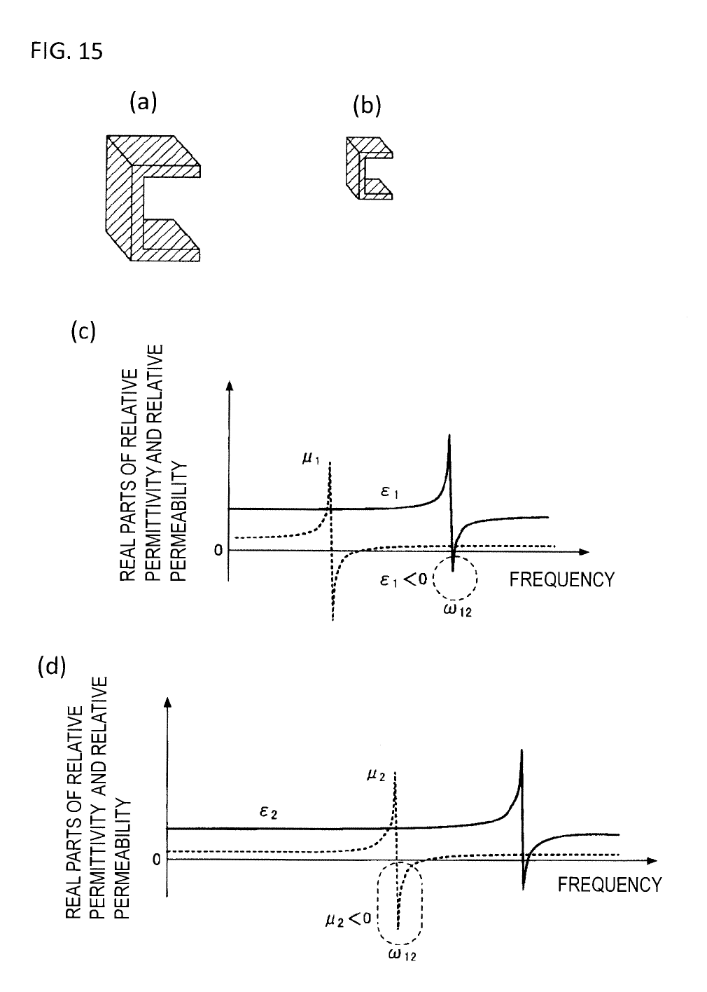

FIGS. 15(a) to (d) are views explaining frequency dependency of permittivity and permeability of electromagnetic wave resonators having different height, width and depth, that is, electromagnetic wave resonators having different size. FIG. 15(a) and FIG. 15(b) are view explaining electromagnetic wave resonators (supports are omitted) having a certain size A and other size B, respectively. FIG. 15(c) and FIG. 15(d) are views explaining frequency dependency of real parts of permittivity and permeability of the electromagnetic wave resonators shown in FIG. 15(a) and FIG. 15(b), respectively. In the electromagnetic wave resonators of FIG. 15(a) and FIG. 15(b), the permittivities are ∈₁ and ∈₂, respectively. In the electromagnetic wave resonators of FIG. 15(a) and FIG. 15(b), the permeability are μ₁ and μ₂, respectively.

In the electromagnetic wave resonator having a certain size A shown in FIG. 15(a), a frequency band in which the permittivity ∈₁ is negative and a frequency band in which the permeability μ₁ is negative are generally different.

However, by combining the electromagnetic wave resonator having a certain size A with the electromagnetic wave resonator having other size B in which the permeability is negative at a frequency band ω₁₂ in which the permittivity is negative, as shown in FIG. 15(c), the refractive index in the frequency band ω₁₂ can be negative (both the permittivity ∈₁ of the electromagnetic wave resonator A and the permeability μ₂ of the electromagnetic wave resonator B are negative).

For example, if the permittivity and permeability are controlled, thereby the refractive index can be negative, in the case of preparing a lens as its application, light can be narrowed down exceeding diffraction limit, and an object lower than wavelength order can be recognized as an optical image. Furthermore, if the permittivity and permeability are controlled, thereby the refractive index can be made negative, when a substance is wrapped with a sheet using the substance, a transparent cloak in which electromagnetic wave passes through the sheet and bypasses the substance, and the phenomenon of cloaking become possible.

The material of the electromagnetic wave resonators 12 is preferably a conductive material such as a metal or a conductive compound. Examples of the conductive material include metals such as aluminum, copper, silver and gold; low resistance carbon such as graphene, an oxide transparent conductive film such as ITO, ZnO or SnO₂, and the like. The material of the electromagnetic wave resonators 12 may be a dielectric. Examples of the dielectric include SiO₂ (relative permittivity: 3.7), Ta₂O₅ (relative permittivity: 29) and BaTiO₃ (relative permittivity: 100).

In the method for producing a metamaterial according to the first embodiment of the present invention, the material of the electromagnetic wave resonators 12 is preferably a dielectric. In this case, loss of an electromagnetic wave with high frequency passing through the metamaterial 13 containing the electromagnetic wave resonators 12 can be reduced.

In the method for producing a metamaterial according to the first embodiment of the present invention, the material of the electromagnetic wave resonators 12 is preferably a conductive material. In this case, resistance magnetic field formed by the electromagnetic wave resonators 12 is stronger. Therefore, relative permeability, refractive index and dispersion of the metamaterial 13 can further effectively be controlled.

The action of the electromagnetic wave resonators 12 is described below. It is considered that when an electromagnetic wave with resonance frequency of an electromagnetic wave resonator enters the electromagnet wave resonators 12, magnetic field of electromagnetic wave periodically fluctuating with time generates conduction current and displacement current in the electromagnetic wave resonators 12 according to Faraday's law of electromagnetic induction. At this time it is considered that the conduction current and displacement current generated in the electromagnetic wave resonators 12 weaken magnetic field of an electromagnetic wave periodically fluctuating with time according to Faraday's law of electromagnetic induction. It is considered that the conduction current and displacement current generated in the electromagnetic wave resonators 12 form resistance magnetic field weakening magnetic field of an electromagnetic wave which has entered the electromagnetic wave resonators 12 according to Ampere's law. As a result, it is considered that the electromagnetic wave resonators 12 change relative permeability of the metamaterial 13 to an electromagnetic wave with resonance frequency of the electromagnetic wave resonators 12. The refractive index of the metamaterial 13 to an electromagnetic wave with resonance frequency of the electromagnetic wave resonators 12 depends on the relative permeability of the metamaterial 13 to an electromagnetic wave with resonance frequency of the electromagnetic wave resonators 12. For this reason, it is considered that the electromagnetic wave resonators 12 change the refractive index (dispersion) of the metamaterial 13 to an electromagnetic wave with resonance frequency of the electromagnetic wave resonators 12.

Energy of the magnetic field of an electromagnetic wave, which enters the electromagnetic wave resonators 12, is reduced by the resistance magnetic field formed by the electromagnetic wave resonators 12. Therefore, it is considered that the electromagnetic wave resonators 12 absorb at least a part of energy of an electromagnetic wave with resonance frequency. Thus, properties of resonance of the electromagnetic wave resonators 12 to an electromagnetic wave with a certain specific frequency (resonance frequency of electromagnetic wave resonator) can be evaluated by absorption of an electromagnetic wave due to the shape of an electromagnetic wave resonator at a certain specific frequency.

A method for evaluating properties of resonance of the electromagnetic wave resonators 12 to an electromagnetic wave with a certain specific frequency is described below.

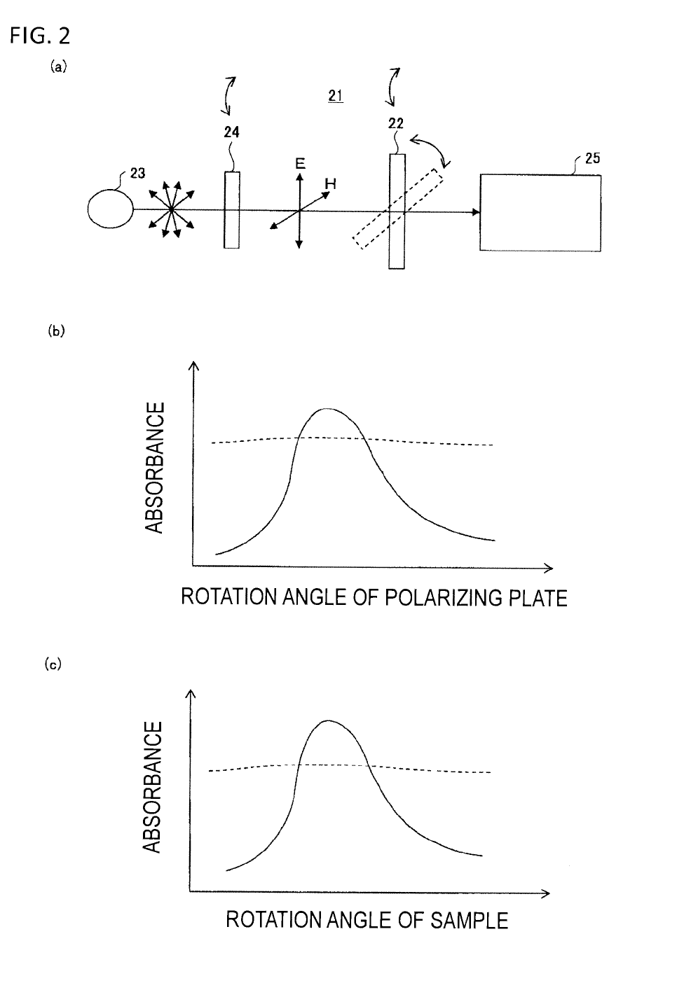

FIGS. 2(a) to (c) are views explaining a method for evaluating properties of resonance of an electromagnetic wave resonator to an electromagnetic wave with a certain specific frequency. FIG. 2(a) is a view explaining an apparatus for evaluating properties of resonance of an electromagnetic wave resonator to an electromagnetic wave with a certain specific frequency.

As shown in FIG. 2(a), an apparatus 21 for evaluating properties of resonance of a sample 22 containing the electromagnetic wave resonators 12 includes a light source 23, a polarizing plate 24 and a spectrophotometer 25. In the apparatus 21, the light source 23 emits non-polarized white light. The non-polarized white light emitted from the light source 23 passes through the polarizing plate 24. The white light passing through the polarizing plate 24 is linearly polarized light. The linearly polarized white light enters the sample 22. When of the linearly polarized white light entering the sample 22, the linearly polarized light of resonance frequency resonates with the electromagnetic wave resonators 12 contained in the sample 22, the linearly polarized light of resonance frequency is absorbed by the electromagnetic wave resonators 12 contained in the sample 22. Absorbance of the linearly polarized light passing through the sample 22 to various wavelengths in white light is measured using the spectrophotometer 25.

Absorbance of particles in the sample 22 to the wavelength of the linearly polarized light is similarly obtained using (substantially) spherical particles prepared by the same material as the material of the electromagnetic wave resonators 12, in place of the electromagnetic wave resonators 12. In the case where significant difference is observed between the absorbance of the electromagnetic wave resonators 12 in the sample 22 and the absorbance of the particles in the sample 22, it is judged that the electromagnetic wave resonators 12 is an electromagnetic wave resonator that resonates, different from simple particles, with an electromagnetic wave.

Whether the electromagnetic wave resonators are randomly arranged in the sample or regularly arranged therein can be examined using the apparatus 21 shown in FIG. 2(a). The apparatus 21 preferably has at least one of the means for rotating the sample 22 and the means for rotating the polarizing plate 24.

After measuring the absorbance of the sample containing the electromagnetic wave resonators by switching a wavelength, a wavelength at which the absorption becomes peak is identified. The wavelength of non-polarized white light emitted from the light source 23 is fixed to the identified wavelength, the polarizing plate is rotated or the sample is rotated, and change in absorbance is observed. The change in absorbance is observed by rotating the sample 22 as shown by a solid line and a broken line, and additionally rotating in H direction. The polarizing plate 24 is rotated in H direction, and change in absorbance is observed. FIG. 2(b) is a view explaining change in absorbance of an electromagnetic wave resonator in the case where a polarizing plate is rotated, and FIG. 2(c) is a view explaining change in absorbance of an electromagnetic wave resonator in the case where a sample is rotated.

In the case where the electromagnetic wave resonators 12 in the sample 22 are regularly arranged, the absorbance of linearly polarized light due to the electromagnetic wave resonators 12 contained in the sample 22 depends on an angle between a direction of the linearly polarized light and a direction of regular arrangement of the electromagnetic wave resonators. For this reason, when the polarizing plate 24 is rotated as shown by a solid line in FIG. 2(b), the absorbance of light due to the electromagnetic wave resonators 12 contained in the sample 22 fluctuates. Furthermore, when the sample 22 is rotated by the means for rotating the sample 22 as shown by a solid line in FIG. 2(c), the absorbance of light due to the electromagnetic wave resonators 12 contained in the sample 22 fluctuates.

In the case where the electromagnetic wave resonators 12 in the sample 22 are randomly arranged, even though the polarizing plate is rotated as shown by a dot line in FIG. 2(b), absorption of light due to the electromagnetic wave resonators 12 contained in the sample 22 does not depend on the rotation of the polarizing plate. Furthermore, even though the sample 22 is rotated by the means for rotating the sample 22 as shown by a dot line in FIG. 2(c), absorption of light due to the electromagnetic wave resonators 12 contained in the sample 22 does not depend on the rotation of the sample 22.

The electromagnetic wave resonators 12 as shown in FIG. 1(b) may be a fine electromagnetic wave resonator having a size of approximately millimeter or less. In this case, resonance frequency of the electromagnetic wave resonators 12 generally falls within a region of frequency of visible light. For this reason, relative permeability/refractive index/dispersion of the metamaterial 13 to a wavelength of visible light can be controlled.

In the first embodiment of the present invention shown in FIG. 1(b), the electromagnetic wave resonators 12 are regularly arranged in the metamaterial 13. However, the electromagnetic wave resonators 12 are sometimes irregularly (randomly) arranged in the metamaterial 13. In the case where the electromagnetic wave resonators 12 are irregularly (randomly) arranged in the metamaterial 13, for example, the metamaterial 13 having physical properties (for example, relative permeability, refractive index and dispersion) that are isotropic to a direction of polarization of an electromagnetic wave can be provided.

Examples of the method for vapor-depositing the material of the electromagnetic wave resonators 12 to the support 11 include physical vapor deposition (PVD) and chemical vapor deposition (CVD).

The physical vapor deposition is means of heating a raw material in a solid state by which the raw material vaporizes and depositing a gas of the vaporized raw material on the surface of a substrate, or means of colliding ions or particles of high energy to a target and depositing particles flied out on the surface of a substrate. Examples of the physical vapor deposition include vacuum vapor deposition, sputtering and ion plating. Examples of the vacuum vapor deposition include electron beam deposition and resistance heating deposition. Examples of the sputtering include direct current (DC) sputtering, alternate current (AC) sputtering, radio-frequency (RF) sputtering, pulsed direct current (DC) sputtering and magnetron sputtering.

The chemical vapor deposition is the means of supplying a raw material gas containing components of an objective thin film and depositing a film by a chemical reaction on a substrate surface or in a gas phase. Examples of the chemical vapor deposition include thermal CVD, light CVD, plasma CVD and epitaxial CVD.

In the method for producing a metamaterial according to the first embodiment of the present invention, the electromagnetic wave resonators 12 having a given shape can be formed on the support 11 without conducting specific treatment (etching, ashing, lift-off or the like) before and after vapor depositon of a material of the electromagnetic wave resonators 12 to the support 11 having a shape corresponding to the shape of the electromagnetic wave resonators 12.

Therefore, according to the first embodiment of the present invention, a method for producing a metamaterial, capable of easily producing the metamaterial 13 containing the electromagnetic wave resonators 12 can be provided.

In the method for producing a metamaterial according to the first embodiment of the present invention, the material of the electromagnetic wave resonators 12 is preferably vapor-deposited by the means of physical vapor deposition. In this case, the electromagnetic wave resonators 12 can be provided on the support 11 without using a chemical reaction of a material of the electromagnetic wave resonators 12. As a result, uniform electromagnetic wave resonators 12 can be provided on the support 11.

As shown in FIG. 1(b), in the method for producing a metamaterial according to the first embodiment of the present invention, the support 11 preferably includes convex portions having a shape containing a flat surface corresponding to the shape of electromagnetic wave resonators 12.

The material of the electromagnetic wave resonators 12 can be vapor-deposited to the support 11 from a direction oblique to a normal line of a flat surface of the support 11.

For example, a supply source of the material of the electromagnetic wave resonators 12 is arranged in a direction oblique to a normal line of a flat surface of the convex portion of the support 11. The material of the electromagnetic wave resonators 12 supplied from the supply source of the material of the electromagnetic wave resonators 12 is vapor-deposited to a flat surface of the convex portion of the support 11.

In this case, vapor deposition of the material of the electromagnetic wave resonators 12 to the surface (side surface and the like) of the support 11 other than the flat surface of the convex portion of the support 11 can be controlled by changing a direction of arranging a supply source of the material of the electromagnetic wave resonators 12. Furthermore, the material of the electromagnetic wave resonators 12 can be vapor-deposited to the support from at least two different directions.

### Second Embodiment

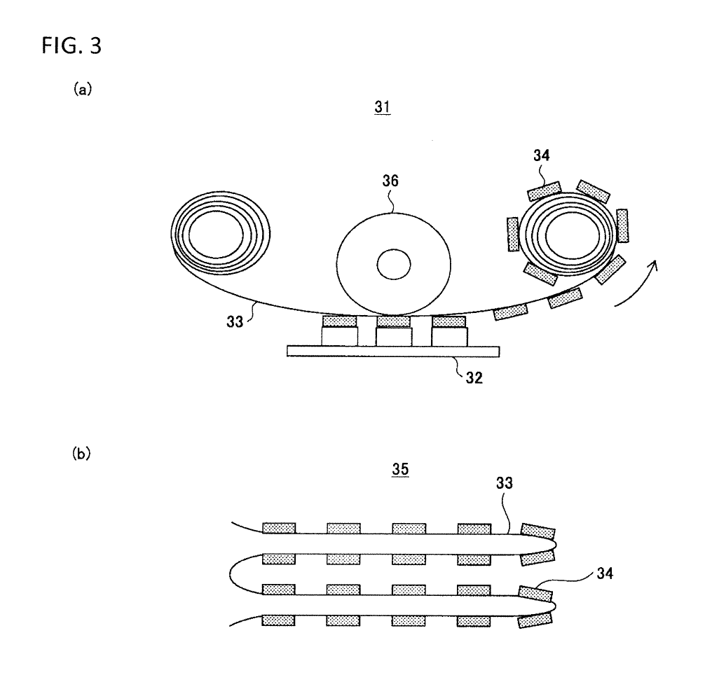

FIGS. 3(a) and (b) are views explaining a method for producing a metamaterial according to a second embodiment of the present invention. FIG. 3(a) is a view showing an apparatus for producing a metamaterial in the method for producing a metamaterial according to the second embodiment of the present invention. FIG. 3(b) is a view showing a metamaterial produced by the method for producing a metamaterial according to the second embodiment of the present invention.

The method for producing a metamaterial according to the second embodiment of the present invention as shown in FIGS. 3(a) and (b) is preferably a method of transferring electromagnetic wave resonators 34 which resonates with an electromagnetic wave and is provided on a support 32 to a material 33 having adhesiveness. The electromagnetic wave resonators 34 provided on the support 32 may be, for example, the electromagnetic wave resonators 12 provided on the support 11 in the method for producing a metamaterial according to the first embodiment of the present invention.

The material 33 having adhesiveness may be a material having viscoelasticity. Examples of the material having viscoelasticity include a silicone rubber.

The method of transferring the electromagnetic wave resonators 34 provided on the support 32 to the material 33 having adhesiveness uses, for example, an apparatus 31 for producing a metamaterial as shown in FIG. 3(a). In the apparatus 31 for producing a metamaterial, a sheet of the material 33 having adhesiveness is pressed to the electromagnetic wave resonators 34 provided on the support 32 using a pressure roller 36. By this, the electromagnetic wave resonators 34 provided on the support 32 can be transferred to the sheet of the material 33 having adhesiveness. As a result, a metamaterial 35 including the sheet of the material 33 having adhesiveness and the electromagnetic wave resonators 34 transferred to the sheet, as shown in FIG. 3(b) is obtained. As shown in FIG. 3(a), the sheet (metamaterial 35) of the material 33 having adhesiveness, to which the electromagnetic wave resonators 34 have been transferred, is wound up.

According to the second embodiment of the present invention, the metamaterial 35 including the sheet of the material 33 having adhesiveness and the electromagnetic wave resonators 34 transferred to the sheet can easily be produced.

The metamaterial containing the electromagnetic wave resonator can further efficiently be obtained by repeatedly or continuously conducting to provide the electromagnetic wave resonators to the support and to recover the electromagnetic wave resonator from the support. Furthermore, a bulk-shaped metamaterial can be produced by laminating the metamaterials 35 and integrating them.

In the method for producing a metamaterial according to the second embodiment of the present invention, the sheet of the material 33 having adhesiveness is preferably a material permeable to an electromagnetic wave with resonance frequency of the electromagnetic wave resonators 34. In this case, the metamaterial 35 itself containing the sheet of the material 33 having adhesiveness and the electromagnetic wave resonators 34 can be used as a functional element such as an optical element without recovering the electromagnetic wave resonators 34 from the sheet of the material 33 having adhesiveness.

### Third Embodiment

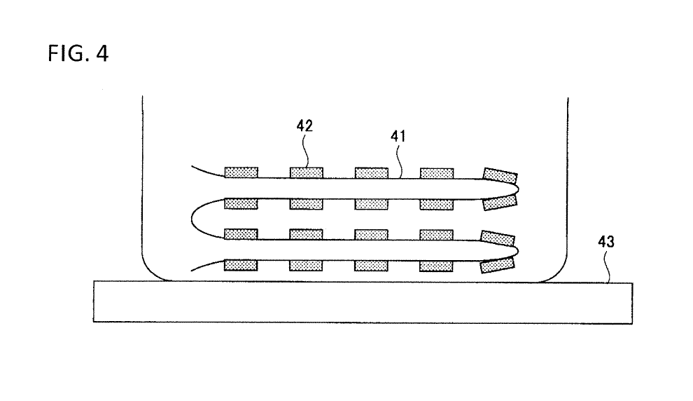

FIG. 4 is a view explaining a method for producing a metamaterial according to a third embodiment of the present invention.

As shown in FIG. 4, the method for producing a metamaterial according to a third embodiment of the present invention includes melting a material 41 having adhesiveness, to which electromagnetic wave resonators 42 resonating with an electromagnetic wave have been transferred, thereby dispersing the electromagnetic wave resonators 42 in the molten material 41 having adhesiveness, and solidifying the molten material 41 having adhesiveness, in which the electromagnetic wave resonators 42 are dispersed.

According to the third embodiment of the present invention, a metamaterial including the solidified material 41 having adhesiveness and the electromagnetic wave resonators 42 dispersed therein can easily be produced.

In the method for producing a metamaterial according to the third embodiment of the present invention, the material 41 having adhesiveness is preferably a sheet of a thermoplastic resin. The sheet of a thermoplastic resin having the electromagnetic wave resonators 42 transferred thereto is heated using a heater 43 or the like. By melting the sheet of a thermoplastic resin, the electromagnetic wave resonators 42 can be dispersed in the molten thermoplastic resin. The thermoplastic resin is then solidified by cooling the molten thermoplastic resin having the electromagnetic wave resonators 42 dispersed therein. As a result, a metamaterial including the thermoplastic resin and the electromagnetic wave resonators 42 dispersed therein is obtained.

When the sheet of the thermoplastic resin having the electromagnetic wave resonators 42 transferred thereto is heated, the molten thermoplastic resin having the electromagnetic wave resonators 42 dispersed therein may be kneaded. In this case, the electromagnetic wave resonators 42 can randomly be dispersed in the molten thermoplastic resin. The thermoplastic resin is then solidified by cooling the molten thermoplastic resin having the electromagnetic wave resonators 42 dispersed randomly therein. As a result, a metamaterial including the thermoplastic resin and the electromagnetic wave resonators 42 dispersed randomly therein is obtained.

### Fourth Embodiment

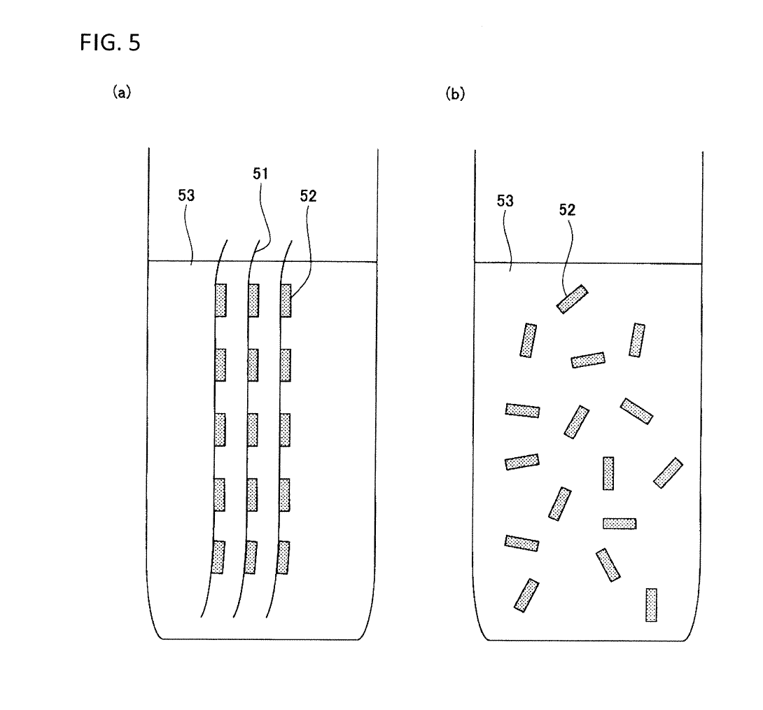

FIGS. 5(a) and (b) are views explaining a method for producing a metamaterial according to a fourth embodiment of the present invention. FIG. 5(a) is a view showing a first step in the method for producing a metamaterial according to the fourth embodiment of the present invention. FIG. 5(b) is a view showing a second step in the method for producing a metamaterial according to the fourth embodiment of the present invention. As shown in FIG. 5(b), electromagnetic wave resonators may be separated from a support. The separation may be conducted in a liquid.

The method for producing a metamaterial according to the fourth embodiment of the present invention as shown in FIGS. 5(a) and (b) includes dipping a material 51 having adhesiveness, to which electromagnetic wave resonators 52 resonating with an electromagnetic wave have been transferred, in a dielectric 53, thereby eliminating the electromagnetic wave resonators 52 from the material 51 having adhesiveness and dispersing the electromagnetic wave resonators 52 in a dielectric 53. The dielectric is preferably a liquid state. In the case where the dielectric is a resin or the like, if the resin has a viscosity such that the electromagnetic wave resonators can sufficiently be dispersed therein, the resin can be used as it is. Furthermore, the resin can be used by melting the same to decrease its viscosity.

According to the fourth embodiment of the present invention, a metamaterial including the dielectric 53 and the electromagnetic wave resonators 52 dispersed therein can easily be produced.

The dielectric 53 is preferably a solvent capable of dissolving the material 51 having adhesiveness. A solution of the material 51 having adhesiveness can be obtained by using the solvent as the dielectric 53. Examples of the solvent include organic solvents such as alcohols, and hydrocarbons such as toluene and tetradecane.

In the method for producing a metamaterial according to the fourth embodiment of the present invention, the dielectric 53 preferably contains a dispersant that improves dispersibility of the electromagnetic wave resonators 52. Sometimes the dispersant is a charge-controlling agent that controls charges of the electromagnetic wave resonators 52.

For example, in the case where a metal material is used as the material of the electromagnetic wave resonators 52, the dispersant is preferably a compound containing a hetero atom having non-covalent electron pair, such as nitrogen atom, sulfur atom or oxygen atom. Examples of the dispersant include dispersants described in, for example, WO2004/110925 and JP-A-2008-263129, the subject matters of which are incorporated herein by reference.

Furthermore, for example, in the case where a dielectric is used as the material of the electromagnetic wave resonators 52, examples of the dispersant include polyacrylic acid, amines, thiols, amino acid and sugars.

In the case where the dielectric 53 contains the dispersant that improves dispersibility of the electromagnetic wave resonators 52, agglomeration of the electromagnetic wave resonators 52 in the dielectric 53 can be reduced. As a result, a metamaterial including the dielectric 53 and the electromagnetic wave resonators 52 more uniformly dispersed therein is obtained.

In the method for producing a metamaterial according to the fourth embodiment of the present invention, the electromagnetic wave resonators are preferably solidified after dispersing in a liquid including a material becoming a transparent dielectric to an electromagnetic wave after solidification, or in a liquid including a material becoming a transparent dielectric to an electromagnetic wave after solidification. Examples of the material becoming a transparent dielectric to an electromagnetic wave after solidification include a curable resin and a glass as described hereinafter. In the case where the material becoming a transparent dielectric to an electromagnetic wave after solidification is a curable resin, the term “after solidification” means “after curing”.

In the method for producing a metamaterial according to the fourth embodiment of the present invention, the dielectric 53 is preferably a curable component.

In the case where the dielectric 53 is a curable component, it becomes possible to cure the dielectric 53. As a result, a metamaterial including the dielectric 53 and the electromagnetic wave resonators 52 dispersed therein can be cured.

The method for producing a metamaterial according to the fourth embodiment of the present invention preferably includes curing the curable component having the electromagnetic wave resonators 52 dispersed therein. To achieve this, the curable component is irradiated with light or heated. As a result, a metamaterial including a cured product obtained by curing the curable component, and the electromagnetic wave resonators 52 dispersed therein is obtained.

The curable component can be any component so long as it is a component becoming a cured product after curing by a polymerization reaction. Radical polymerization type curable resins, cationic polymerization type curable resins and radical polymerization type curable compounds (monomers) can be used without particular limitation. Those may be photo-curable and may be heat-curable, and are preferably photo-curable.

Examples of the radical polymerization type curable resins include resins having a group having a carbon-carbon unsaturated double bond, such as (meth)acryloyloxy group, (meth)acryloylamino group, (meth)acryloyl group, allyloxy group, allyl group, vinyl group or vinyloxy group. Examples of the resins include acrylic polymers having (meth)acryloyioxy group in a side chain thereof.

Examples of the cationic polymerization type curable resin include epoxy resins. Examples of the epoxy resins include hydrogenated bisphenol A epoxy resin, and 3,4-epoxycyclohexenylmethyl-3′,4′-epoxycyclohexene carboxylate.

Examples of the radical polymerization type curable compounds (monomers) include compounds having a group having a carbon-carbon unsaturated double bond, such as (meth)acryloyloxy group, (meth)acryloylamino group, (meth)acryloyl group, allyloxy group, allyl group, vinyl group or vinyloxy group. The group having a carbon-carbon unsaturated double bond is preferably (meth)acryloyloxy group. The number of the carbon-carbon unsaturated double bond in those compounds is not particularly limited, and may be 1 and may be 2 or more.

Examples of those curable compounds include fluoro(meth)acrylates, fluorodienes, fluorovinylethers, fluorocyclic monomers, (meth)acrylates of monohydroxy compounds, mono(meth)acrylates of polyhydroxy compounds, and urethane (meth)acrylates obtained using polyether polyol. Those are used alone, and may be used by appropriately combining at least one kind selected from those. Those curable components preferably contain an appropriate polymerization initiator.

In the case where the curable component is a photocurable component, the dielectric 53 can further easily be cured by irradiating the dielectric 53 with light. As a result, a metamaterial including the dielectric 53 and the electromagnetic wave resonators 52 dispersed therein can further easily be cured.

In the method for producing a metamaterial according to the fourth embodiment of the present invention, the resin cured product obtained by curing the curable component is preferably permeable to an electromagnetic wave.

In this case, a metamaterial itself containing the resin obtained by curing the curable component and the electromagnetic wave resonators 52 can be used as a functional element such as an optical element.

In the method for producing a metamaterial according to the fourth embodiment of the present invention, the dielectric 53 is preferably a glass.

In the case where the dielectric 53 is a glass, a metamaterial including the glass and the electromagnetic wave resonators 52 dispersed therein can be provided.

The method for producing a metamaterial according to the fourth embodiment of the present invention preferably includes solidifying raw materials of a glass in a molten state, which has the electromagnetic wave resonators 52 dispersed therein. This can be carried out by melting glass raw materials after dispersing the electromagnetic wave resonators in raw materials of a glass, followed by cooling, or by dispersing the electromagnetic wave resonators in molten glass raw materials, followed by cooling.

In this case, a metamaterial including the glass obtained by solidifying glass raw materials, and the electromagnetic wave resonators 52 dispersed therein can be provided.

In the method for producing a metamaterial according to the fourth embodiment of the present invention, the glass is preferably a low melting point glass and a phosphate glass. The low melting point glass is a glass having a yield point of 550° C. or lower. Example of the low melting point glass includes a lead-free low melting point glass described in, for example, JP-A-2007-269531, the subject matter of which is incorporated herein by reference.

In the case where the glass is a low melting point glass, raw material of the glass can be melted at a relatively low temperature. For this reason, a metamaterial including the glass and the electromagnetic wave resonators 52 dispersed therein at a relatively low temperature can be provided.

When the raw materials of the low melting point glass in a molten state are cooled, a metamaterial including the low melting point glass and the electromagnetic wave resonators 52 dispersed therein can be provided.

In the method for producing a metamaterial according to the fourth embodiment of the present invention, a sol containing the electromagnetic wave resonators 52 resonating with an electromagnetic wave by dispersing the electromagnetic wave resonators 52 in the dielectric 53 is preferably obtained.

In this case, a metamaterial of a sol including the dielectric 53 and the electromagnetic wave resonators 52 dispersed therein can be provided.

The method for producing a metamaterial according to the fourth embodiment of the present invention preferably includes solidifying a sol containing electromagnetic wave resonators resonating with an electromagnetic wave. In this case, a metamaterial of a gel including the dielectric 53 and the electromagnetic wave resonators 52 dispersed therein can be provided.

To solidify a sol containing the electromagnetic wave resonators resonating with an electromagnetic wave, for example, the sol containing the electromagnetic wave resonators resonating with an electromagnetic wave is heated. The term “to solidify a sol” used herein includes forming a gel by simply solidifying a sol, and additionally includes curing with a reaction in the case where raw materials for obtaining a sol have reactivity. For example, in the case where the raw material for obtaining a sol is alkoxysilanes described hereinafter, a metamaterial of a gel having the electromagnetic wave resonators 52 dispersed therein can be provided by the reaction that the alkoxysilanes are cured by hydrolysis polycondensation reaction.

The raw materials for obtaining a sol are not particularly limited, and examples thereof include metal alkoxides, catalysts such as an acid or a base, and a mixture containing a solvent. Examples of the metal alkoxides include tetraethoxysilane, triethoxyphenylsilane and tetraisopropyloxytitanium.

The method for producing a metamaterial according to the fourth embodiment of the present invention may be a method of impregnating a fiber with the dielectric 53 having the electromagnetic wave resonators 52 dispersed therein. In this case, a metamaterial of a fiber impregnated with the electromagnetic wave resonators 52 and the dielectric 53 can be provided.

### Fifth Embodiment

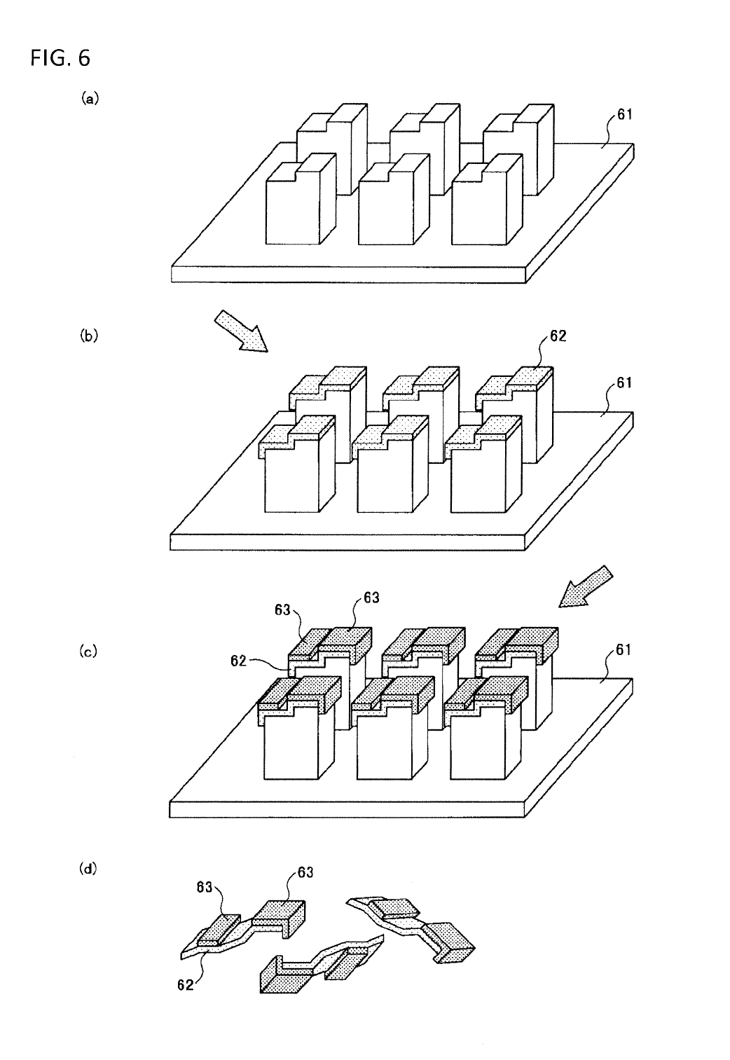

FIGS. 6(a) to (d) are views explaining a method for producing a metamaterial according to a fifth embodiment of the present invention. FIG. 6(a) is a view explaining a support in the method for producing a metamaterial according to the fifth embodiment of the present invention. FIG. 6(b) is a view explaining a first step in the method for producing a metamaterial according to the fifth embodiment of the present invention. FIG. 6(c) is a view explaining a second step in the method for producing a metamaterial according to the fifth embodiment of the present invention. FIG. 6(d) is a view explaining electromagnetic wave resonators in the method for producing a metamaterial according to the fifth embodiment of the present invention.

As shown in FIG. 6(a), in the method for producing a metamaterial according to the fifth embodiment of the present invention, a support 61 for supporting electromagnetic wave resonators is prepared using, for example, a nanoimprint method. The support 61 as shown in FIG. 6(a) has a shape of two flat surfaces having a difference in level therebetween, corresponding to a shape of two flat plates having fine gap of the electromagnetic wave resonators provided therebetween. The support 61 is, for example, composed of a fluorine resin.

As shown in FIG. 6(b), in the method for producing a metamaterial according to the fifth embodiment of the present invention, a dielectric 62 is vapor-deposited to the support 61 having a shape corresponding to the shape of the electromagnetic wave resonators 63 using the means of physical vapor deposition. Supply source supplying the dielectric 62 is arranged to the side facing two flat surfaces and a flat surface of a difference in level between the two flat surfaces, of the support 61. The dielectric 62 supplied from the supply source is vapor-deposited to at least the two flat surfaces and the flat surface of a difference in level, of the support 61. The dielectric 62 is supplied toward the support 61 from an oblique direction to a normal line of two flat surfaces of the support 61. Thus, a continuous film of the electric 62 covering two flat surfaces and the flat surface of a difference in level between the two flat surfaces, of at least the support 61 is provided. The film of the dielectric 62 has a shape of two flat surfaces corresponding to the shape of two flat surfaces of the support 61.

As shown in FIG. 6(c), in the method for producing a metamaterial according to the fifth embodiment of the present invention, a material of the electromagnetic wave resonators 63 is vapor-deposited to the film of the dielectric 62 provided on the support 61 using, for example, the means of physical vapor deposition. Supply source supplying a material of the electromagnetic wave resonators 63 is arranged to the side opposite to the surface facing two flat surfaces and the flat surface of a difference in level between the two flat surfaces, of the support 61. The material of the electromagnetic wave resonators 63 supplied from the supply source is vapor-deposited to the at least two flat surfaces of the film of the dielectric 62. The material of the electromagnetic wave resonators 63 is supplied toward the film of the dielectric 62 from an oblique direction to a normal line of the two flat surfaces of the film of the dielectric 62. As a result, the material of the electromagnetic wave resonators 63 is vapor-deposited to two flat surfaces of the film of the dielectric 62, but is not vapor-deposited to a portion of the film of the dielectric 62 in the vicinity of the flat surface of a difference in level of the support 61. Thus, the electromagnetic wave resonator 63 having a shape of two flat plates having fine gap provided therebetween is formed on the continuous film of the dielectric 62 provided on the support 61.

In other words, a metamaterial including the support 61, the film of the dielectric 62 and the electromagnetic wave resonators 63 can be produced.

Thus, in the method for producing a metamaterial according to the fifth embodiment of the present invention as shown in FIG. 6(b) and FIG. 6(c), vapor deposition of the material of the electromagnetic wave resonators 63 to the support 61 includes the vapor deposition of the dielectric 62 to the support 61 and the vapor deposition of the material of the electromagnetic wave resonators 63 to the dielectric 62.

For example, a laminate of the film of the dielectric 62 and the electromagnetic wave resonator 63 composed of a conductive material, as shown in FIG. 6(d), can be provided.

In this case, as shown in FIG. 6(d), a metamaterial including the dielectric 62 and the electromagnetic wave resonators 63 can be provided. Furthermore, even when the electromagnetic wave resonator 63 includes a plurality of constituent parts, a plurality of the constituent parts of the electromagnetic wave resonator 63 can be integrated by the dielectric 62.

As shown in FIG. 6(a), FIG. 6(b) and FIG. 6(c), in the method for producing a metamaterial according to the fifth embodiment of the present invention, the support 61 has a shape including a flat surface corresponding to the shape of the electromagnetic wave resonator 63. On the other hand, the dielectric 62 is vapor-deposited to the flat surface of the support 61 from a first oblique direction to a normal line of the flat surface of the support 61 and, additionally, the material of the electromagnetic wave resonator 63 is vapor-deposited to the dielectric 62 from a second oblique direction that is opposite to the first oblique direction to a normal line of the flat surface of the support 61.

In this case, various metamaterials including the dielectric 62 and the electromagnetic wave resonator 63 can be provided by adjusting conditions for the vapor-deposition of the dielectric 62 to the flat surface of the support 61 and conditions for the vapor-deposition of the material of the electromagnetic wave resonator 63 to the dielectric 62.

The electromagnetic wave resonator 63 as shown in FIG. 6(d) has a shape constituting a kind of LC circuit. As shown in FIG. 6(d), in the method for producing a metamaterial according to the fifth embodiment of the present invention, the shape of the electromagnetic wave resonators 63 is a shape of two flat plates having a fine gas provided therebetween. Thus, the shape of the electromagnetic wave resonators 63 has a shape of two flat plates through a gap such that the electromagnetic wave resonator 63 has capacitance. The electromagnetic wave resonators 63 shown in FIG. 6(d) have a gap between two flat plates held by the dielectric 62. Furthermore, the shape of the electromagnetic wave resonators 63 has a structure capable of forming a loop by conduction current and displacement current such that the electromagnetic wave resonators 63 have inductance. The electromagnetic wave resonators 63 shown in FIG. 6(d) have a structure capable of forming a loop by semi-looped conduction current flowing through one flat plate, semi-looped conduction current flowing through the other flat plate, and displacement current generated in a gap between the flat plates and integrated to semi-looped conduction currents flowing through two flat plates.

The material of the electromagnetic wave resonators 63 may be a conductive material such as a metal or a conductive compound, and may be a dielectric. In the method for producing a metamaterial according to the fifth embodiment of the present invention, the material of the electromagnetic wave resonators 63 is preferably a dielectric. In this case, loss of high-frequency electromagnetic wave passing the metamaterial containing the electromagnetic wave resonators 63 can be reduced.

The electromagnetic wave resonators 63 as shown in FIG. 6(d) may be a fine electromagnetic wave resonator having a size of approximately millimeter or less. In this case, resonance frequency of the electromagnetic wave resonators 63 generally falls within a range of a frequency of visible light. For this reason, the relative permeability, refractive index and dispersion of a metamaterial to a wavelength of visible light can be controlled.

In the fifth embodiment of the present invention as shown in FIG. 6(c), the electromagnetic wave resonators 63 are regularly arranged on the support 61. However, sometimes the electromagnetic wave resonators 63 are irregularly (randomly) arranged in a metamaterial as shown in FIG. 6(d). In the case where the electromagnetic wave resonators 63 are irregularly (randomly) arranged in a metamaterial, for example, a metamaterial having physical properties (for example, relative permeability, refractive index and dispersion) isotropic to a polarization direction of an electromagnetic wave can be provided.

### Sixth Embodiment

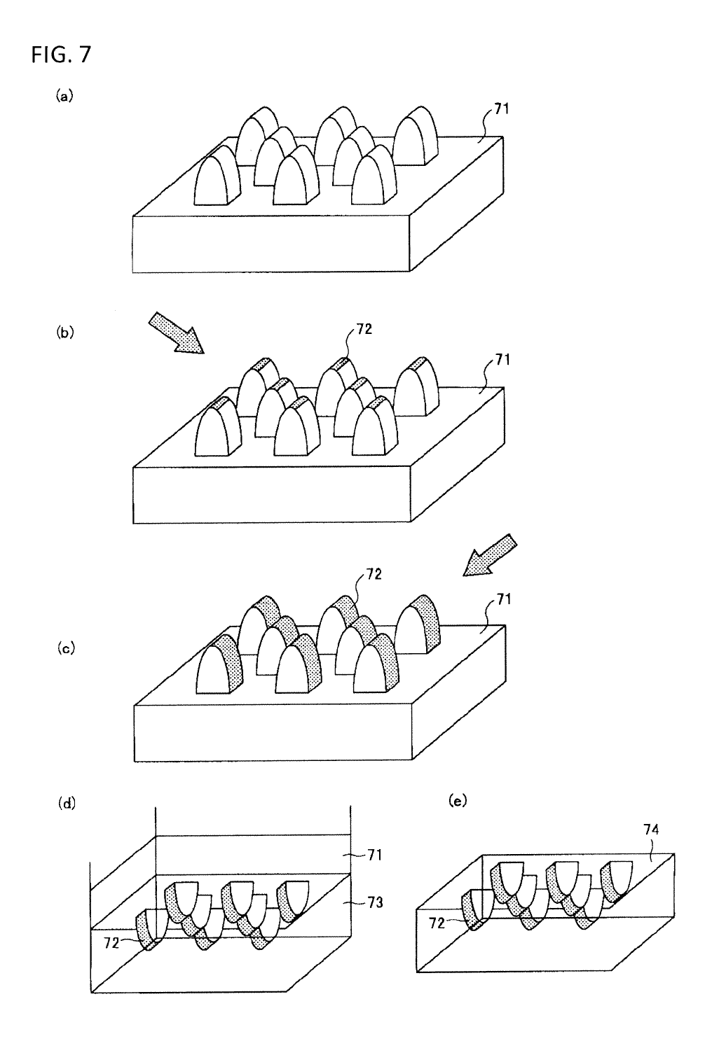

FIGS. 7(a) to (e) are views explaining a method for producing a metamaterial according to a sixth embodiment of the present invention. FIG. 7(a) is a view explaining a support in the method for producing a metamaterial according to the sixth embodiment of the present invention. FIG. 7(b) is a view explaining a first step in the method for producing a metamaterial according to the sixth embodiment of the present invention. FIG. 7(c) is a view explaining a second step in the method for producing a metamaterial according to the sixth embodiment of the present invention. FIG. 7(d) is a view explaining a third step in the method for producing a metamaterial according to the sixth embodiment of the present invention. FIG. 7(e) is a view explaining a metamaterial in the method for producing a metamaterial according to the sixth embodiment of the present invention.

As shown in FIG. 7(a), in the method for producing a metamaterial according to the sixth embodiment of the present invention, a support 71 for supporting electromagnetic wave resonators is prepared using, for example, a nanoimprint method. The support 71 as shown in FIG. 7(a) has an approximate inverted U-shaped convex curved surface shape corresponding to a curved surface shape of the inverted U-shaped electromagnetic wave resonators. The support 71 is, for example, composed of a fluorine resin.

As shown in FIG. 7(b), in the method for producing a metamaterial according to the sixth embodiment of the present invention, a material of the electromagnetic wave resonators 72 is vapor-deposited to the support 71 having a shape corresponding to the shape of the electromagnetic wave resonators 72 resonating with an electromagnetic wave using, for example, the means of physical vapor deposition. Supply source supplying the material of the electromagnetic wave resonators 72 is arranged to the side of a first direction that is an oblique direction to a flat surface of the support 71. The material of the electromagnetic wave resonators 72, supplied from the supply source is vapor-deposited to a part of the approximate U-shaped convex curved surface of the support 71. Thus, a part of the electromagnetic wave resonators 72 is provided on the first part of the approximate U-shaped convex curved surface of the support 71.

As shown in FIG. 7(c), in the method for producing a metamaterial according to the sixth embodiment of the present invention, the material of the electromagnetic wave resonators 72 is vapor-deposited to the support 71 having a shape corresponding to the shape of the electromagnetic wave resonators 72 using, for example, the means of physical vapor deposition. Supply source supplying the material of the electromagnetic wave resonators 72 is arranged to the side of a second direction that is an oblique direction to the flat surface of the support 71. The second direction is a direction different from the first direction. The material of the electromagnetic wave resonators 72 supplied from the supply source is vapor-deposited to a second part of an approximate inverted U-shaped convex curved surface of the support 71. Thus, the electromagnetic wave resonators 72 are provided on the second part of an approximate inverted U-shaped convex curved surface of the support 71. The first part and the second part may partially be overlapped.

As a result, a metamaterial containing the support 71 and the electromagnetic wave resonators 72 covering the whole of the approximate inverted U-shaped convex curved surface of the support 71 can be produced. In this case, from the relationship with a direction of obliquely vapor-depositing to a position of a projection of the support, only a part of the support is vapor-deposited, and root and bottom of the projection can be avoided from the attachment of a deposit by vapor deposition. This is an excellent point in productivity of this method. In other words, because the deposit is attached to only the portion of the electromagnetic wave resonators that develop resonance function, an etching step used in the conventional lithography becomes unnecessary, and productivity can remarkably be improved.

Thus, in the method for producing a metamaterial according to the sixth embodiment of the present invention as shown in FIG. 7(b) and FIG. 7(c), the material of the electromagnetic wave resonators 72 is vapor-deposited to the support 71 from the first direction and the second direction different from first direction.

The material of the electromagnetic wave resonators 72 is vapor-deposited to the support 71 from the first direction and the second direction different from the first direction by, for example, changing a position and/or an angle of the supply source of the material of the electromagnetic wave resonators 72 to the support 71.

In this case, the material of the electromagnetic wave resonators 72 can further precisely be vapor-deposited to the support 71 by further appropriately selecting the first direction and the second direction.

The electromagnetic wave resonators 72 as shown in FIG. 7(c) have a shape constituting a kind of LC circuit. As shown in FIG. 7(c), in the method for producing a metamaterial according to the sixth embodiment of the present invention, the electromagnetic wave resonators 72 have an “inverted U-shape”. The “inverted U-shaped electromagnetic wave resonators” 72 shown in FIG. 7(c) have a gap between both end parts of an “inverted U-shaped” curved surface. The shape of the electromagnetic wave resonators 72 has a structure capable of forming a loop by conduction current and displacement current such that the electromagnetic wave resonators 72 have inductance. The electromagnetic wave resonators 72 shown in FIG. 7(c) have a structure capable of forming a loop by conduction current flowing from one end part of the “inverted U-shaped” curved surface to the other end part thereof and displacement current generated in a gap between both end parts of the approximate inverted U-shape.

The material of the electromagnetic wave resonators 72 may be a conductive material such as a metal or a conductive compound, and may be a dielectric. In the method for producing a metamaterial according to the sixth embodiment of the present invention, the material of the electromagnetic wave resonator 72 is preferably a dielectric. In this case, loss of a high-frequency electromagnetic wave passing through a metamaterial containing the electromagnetic wave resonators 72 can be reduced.

The electromagnetic wave resonators 72 as shown in FIG. 7(c) may be a fine electromagnetic wave resonator having a size of approximately millimeter or less. In this case, resonance frequency of the electromagnetic wave resonators 72 falls within a range of a frequency of visible light. For this reason, relative permeability/refractive index/dispersion of a metamaterial to a wavelength of visible light can be controlled.

In the sixth embodiment of the present invention shown in FIG. 7(c), the electromagnetic wave resonators 72 are regularly arranged on the support 71. However, sometimes the electromagnetic wave resonators 72 are irregularly (randomly) arranged in the metamaterial. In the case where the electromagnetic wave resonators 72 are irregularly (randomly) arranged in the metamaterial, for example, a metamaterial having physical properties (for example, relative permeability, refractive index and dispersion) isotropic to a direction of polarization of an electromagnetic wave can be provided.

In the method for producing a metamaterial according to the sixth embodiment of the present invention, for example, as shown in FIG. 7(d), a curable resin 73 is brought into contact with the electromagnetic wave resonator 72 provided on the support 71, and the curable resin 73 is cured.

As shown in FIG. 7(e), the support 71 is removed from a cured product 74 of a resin obtained by curing the curable resin 73. As a result, a metamaterial comprising the cured product 74 of a resin and concave electromagnetic wave resonators 72 arranged thereon can be obtained. Thus, the concave electromagnetic wave resonators 72 can be transferred to the cured product 74 of a resin.

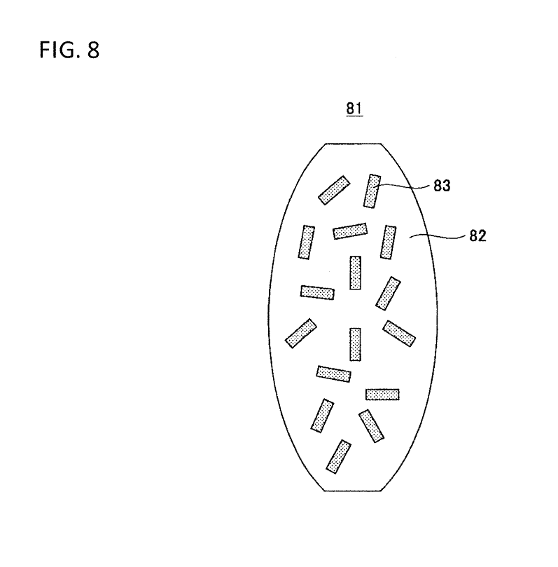

FIG. 8 is a view explaining an example of a metamaterial produced by the embodiment(s) of the present invention. A metamaterial 81 shown in FIG. 8 is an optical element including a cured product 82 of a resin and electromagnetic wave resonators 83. The metamaterial 81 shown in FIG. 8 is a lens. In the metamaterial 81, the electromagnetic wave resonators 83 are irregularly (randomly) dispersed in the cured product 82 of a resin. For this reason, the metamaterial 81 is, for example, a lens having physical properties (for example, relative permeability, refractive index and dispersion) isotropic to a polarization direction of an electromagnetic wave. Furthermore, a lens having adjusted isotropic physical properties (for example, relative permeability, refractive index and dispersion) can be provided by appropriately designing the electromagnetic wave resonators 83 dispersed in the cured product 82 of a resin.

### EXAMPLES

### Examples of the present invention are described below

### Example 1

A metamaterial was prepared by the following method.

Using a quartz glass mold having a hole structure, projection structure was transferred to a fluorine-based UV photocured resin (NIF-A-2, manufactured by Asahi Glass Co., Ltd.) using a nanoimprint apparatus. Each projection of the fluorine-based UV photocured resin had a pillar shape having a cross-section of 100 nm×100 nm and a height of about 400 nm.

Aluminum was vapor-deposited to the projection structure made of UV photocured resin from oblique two directions to prepare a metamaterial.

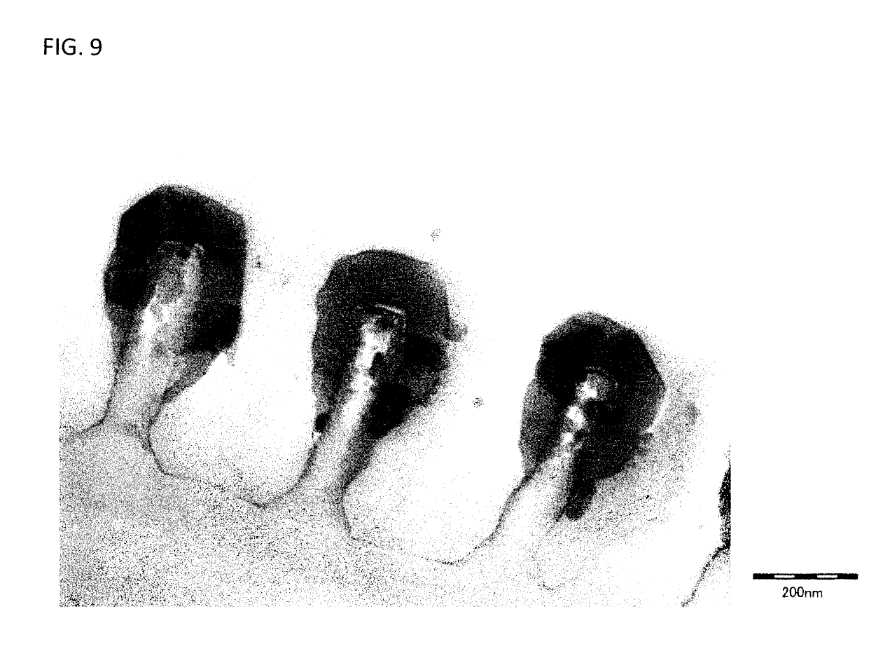

FIG. 9 shows a TEM observation photograph of the metamaterial.

In the photograph, an inverted U-shaped part observed darkly corresponds to an aluminum-made electromagnetic wave resonator.

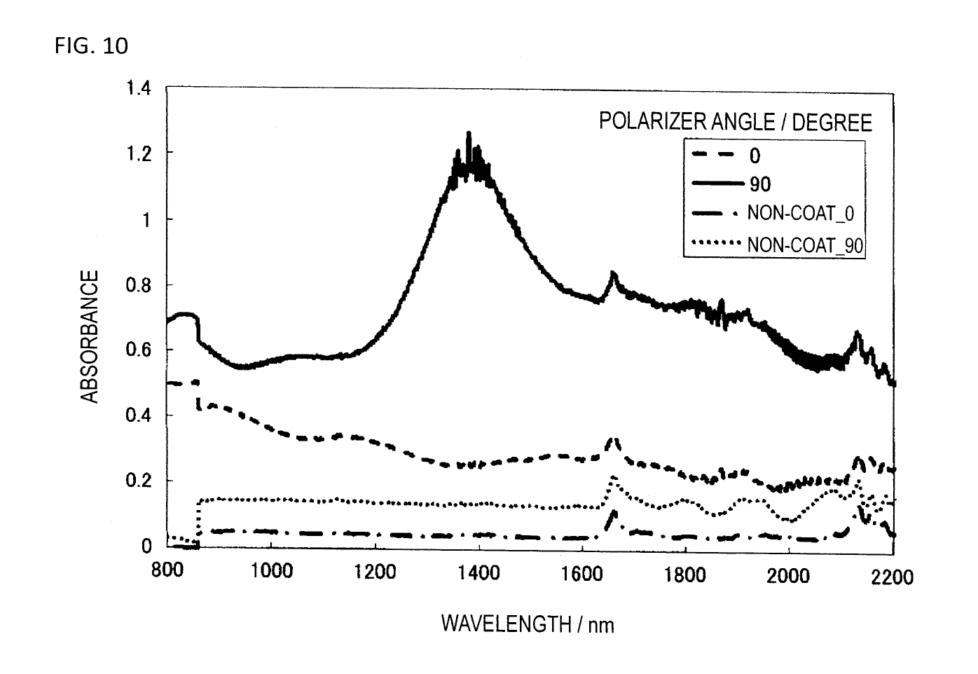

FIG. 10 shows the results that regarding a sample prepared by the same preparation method as the electromagnetic wave resonator of FIG. 9 and a sample obtained by subjecting a fluorine-based UV photocured resin (NIF-A-2, manufactured by Asahi Glass Co., Ltd.) to nanoimprint, but not subjecting to vapor deposition of aluminum, absorbance was measured by changing a polarization direction 90°. It was confirmed in the sample having been subjected to aluminum vapor deposition that in the case of entering light in a direction that magnetic field penetrates through an electromagnetic wave resonator, resonance absorption could be observed at a center wavelength of about 1,400 nm, and a structure that functions in the wavelength region could be formed.

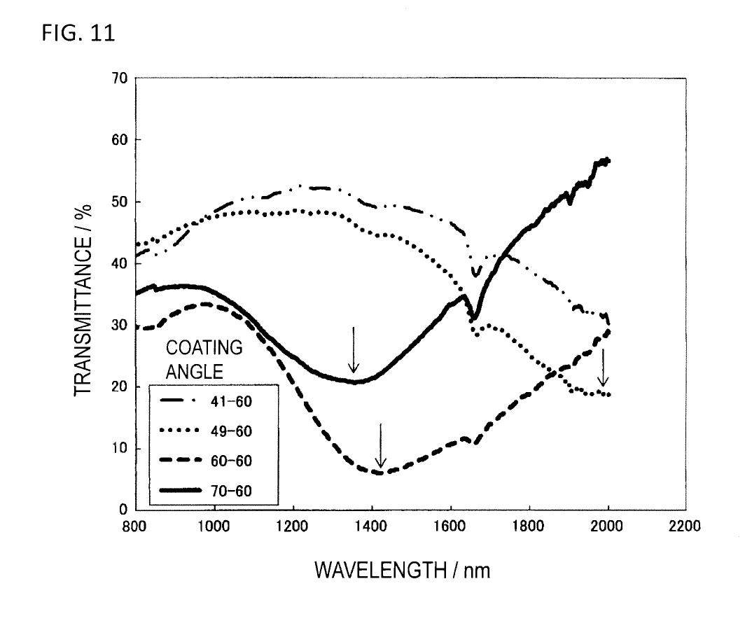

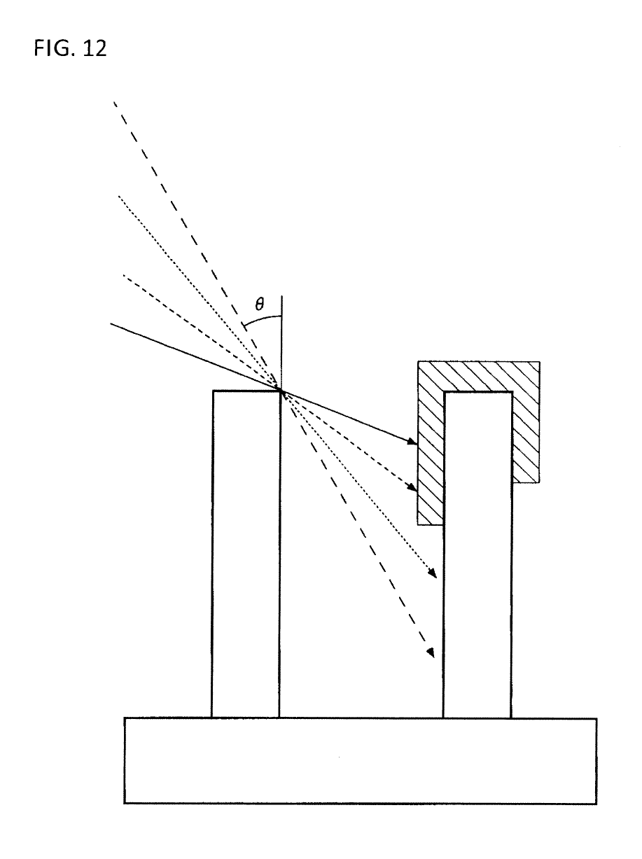

FIG. 11 shows a transmission spectrum when oblique vapor deposition of aluminum has been conducted by changing vapor deposition angle as shown in FIG. 12, in preparing a resonator structure by the same preparation method as the preparation of the electromagnetic wave resonator shown in FIG. 9. The graph legends in FIG. 11 mean that when the case of vertically vapor-depositing to a transferred surface of a UV cured resin is 0° as an angle of oblique vapor deposition, for example, in the indication of 41-60, oblique vapor deposition is first conducted from a direction of 41°, and oblique vapor deposition is then conducted at 60° from a direction opposite to the angle. As shown by an arrow in FIG. 11, it is seen that resonance absorption band can be changed by changing an angle of oblique vapor deposition. It is predicted that a resonance absorption band of a curve shown by 41-60 appears at further long wavelength side of this graph from the relationship with a shape of the other curves.

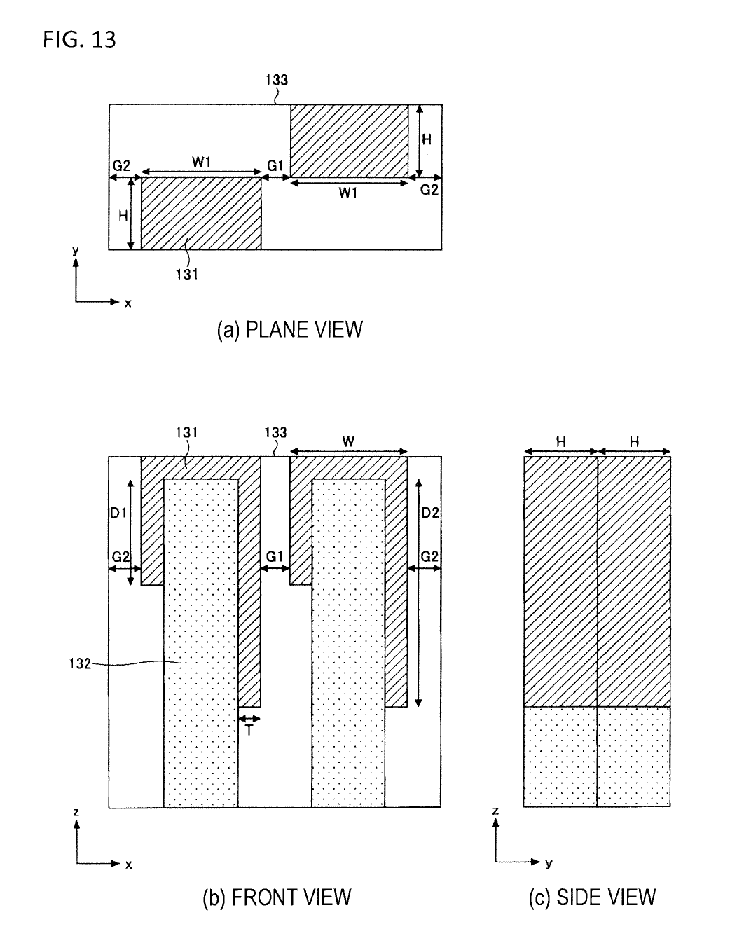

FIGS. 13(a) to (c) show a unit cell 133 used when, of the “C-shaped electromagnetic wave resonators”, electromagnetic wave resonators showing negative values of both permeability and permittivity in the same frequency band by making a length of one side longer than that of a side facing the one side were analyzed by three-dimensional electromagnetic field analysis. The analysis results are the results to electromagnetic wave resonators in which the unit cells 133 were periodically arranged unlimitedly in x direction and y direction.

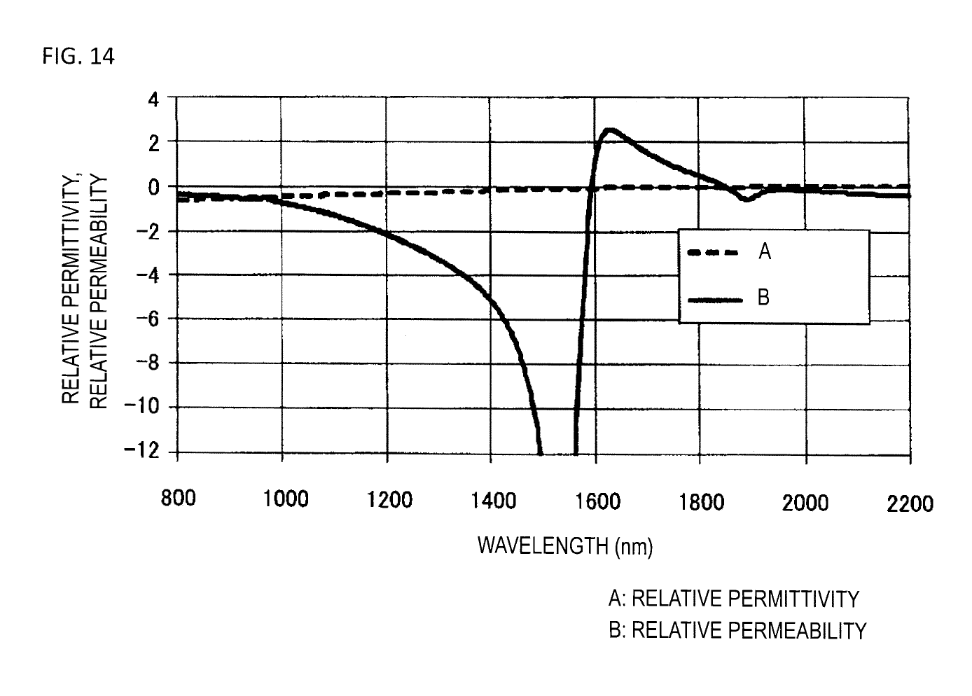

As an example of the analysis carried out, a conductor 131 used was aluminum, and a support 132 used was a dielectric having a permittivity of 2. The electromagnetic wave was a plane and vertically entered along z direction. Direction of electric field of the plane wave was x direction, and direction of magnetic field was y direction. The respective dimensions of the electromagnetic wave resonators are that the aluminum has width W1=160 nm, height H=100 nm, depth D1=173 nm, width D2=346 nm, and thickness T=30 nm, and the support has depth D3=450 nm, width W2=100 nm, and gaps G1 of C-shaped electromagnetic wave resonators=40 nm and G2=50 nm. The results analyzed are shown in FIG. 14. It is seen that both the relative permittivity and the relative permeability show negative values in the vicinity of from 800 to 1,600 nm.

### Example 2

A metamaterial in which electromagnetic wave resonators were formed by graphene was produced by the following procedures.

(First Step)

A mold having a transfer pattern on the surface thereof and a quartz glass substrate having 20 mm long×20 mm wide×0.5 mm thick were prepared.

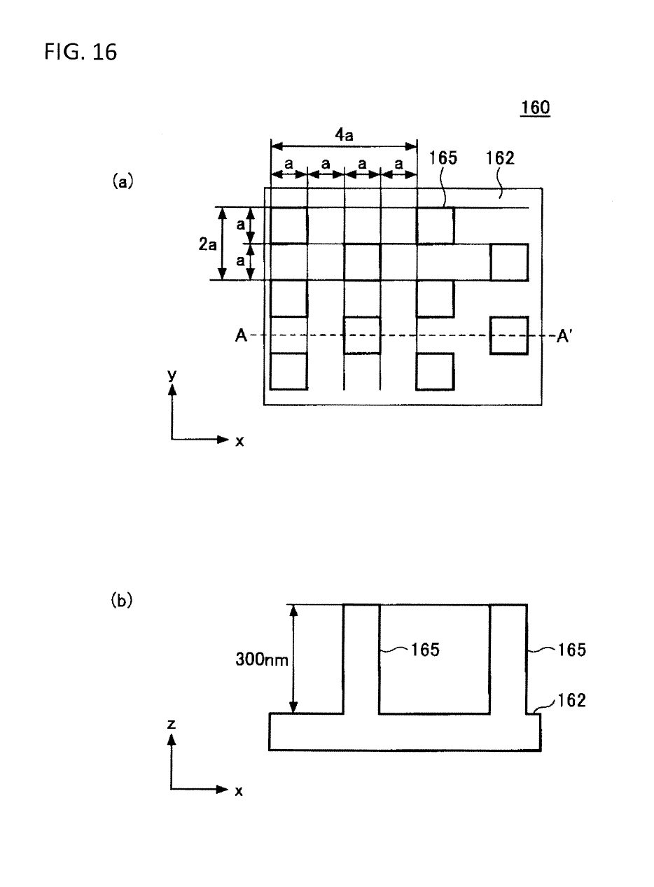

The mold was made of quartz glass, and a pattern shown in FIGS. 16(a) and 16(b) was used as the transfer pattern.

FIG. 16(a) is a front view of a pattern surface 162 of a mold 160. FIG. 16(b) is a cross-sectional view taken along A-A′ line of the mold 160.

In FIGS. 16(a) and (b), a square shape indicated by reference 165 shows a quadrangular pillar 165. Length a of one side of a bottom surface of the pillar 165 is 100 nm, and a height thereof is 300 nm.

The pattern of a mold can be prepared by, for example, a method of combining EB lithography and dry etching.

(Second Step)

A fluorine-based UV photocurable resin (NIF-A-2, manufactured by Asahi Glass Co., Ltd.) was applied to the pattern surface 162 of the mold 160 in a thickness of about 2 μm, and the mold 160 was pressed to a region of 5 mm×5 mm of a quartz glass substrate using a nanoimprint apparatus. After curing the fluorine-based UV photocurable resin, the mold 160 was removed, thereby transferring projection structure constituted of the UV photocured resin, having inverted concavo-convex pattern to the concavo-convex pattern shown in FIGS. 16(a) and 16(b). Unnecessary film attached to a bottom surface part of a pattern-formed surface of the quartz glass substrate was then removed by an oxygen plasma ashing method, and only projections were remained.

(Third Step)

A metallic nickel film was formed on the pattern surface of the quartz glass substrate using a sputtering apparatus. The sputtering was carried out from a vertical direction to the pattern surface of the quartz glass substrate. As a result, the metallic nickel film was formed on an upper surface of the projection and a projection-free surface of the quartz glass substrate.

The quartz glass substrate obtained was dipped in a potassium hydroxide aqueous solution, and the fluorine-based UV photocured resin was selectively removed by lift-off. As a result, a quartz glass substrate in which, of the pattern surface of the quartz glass substrate, a surface of a portion having projection was exposed and other portion was formed by a nickel film, was obtained.

Using SF₆ as an etching gas, etching was conducted to a nickel film-free portion of the quartz glass substrate using a nickel film as a mask by RIE (Reactive Ionic Etching) apparatus. By the etching, pillar projection pattern of 100 nm long×100 nm wide×350 nm high, having the nickel film on the uppermost surface was formed. Thereafter, only the nickel film was removed.

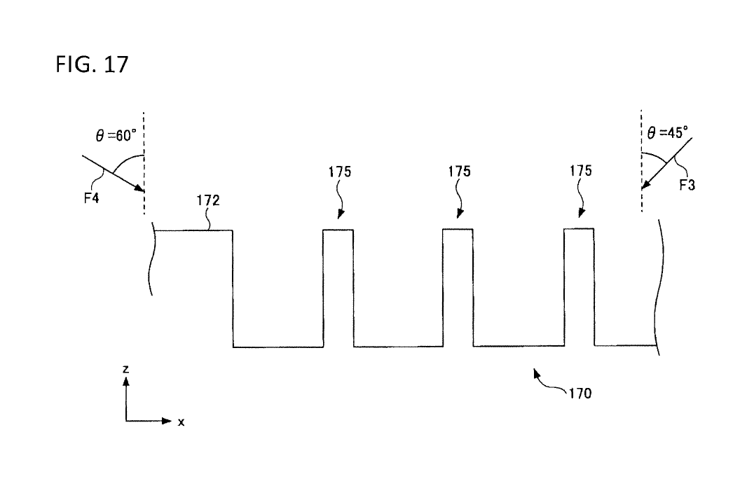

FIG. 17 schematically shows a pillar projection pattern of a quartz glass substrate 170. A plurality of pillars 175 (constituted of the remaining part of the quartz glass substrate 170) were formed on the quartz glass substrate 170 in regular arrangement.

(Fourth Step)

Aluminum was vapor-deposited to a surface 172 of the quartz glass substrate 170 from different two oblique directions. Thus, aluminum was vapor-deposited in an inverted U-shape to each pillar 175.

More specifically, first aluminum vapor deposition was conducted such that an angle to a thickness direction of the quartz glass substrate 170 was about 70° as shown by an arrow F3 in FIG. 17. Second aluminum vapor deposition was then conducted such that an angle to a thickness direction of the quartz glass substrate 170 is about −60° as shown by an arrow F4 in FIG. 17.

In the pattern arrangement of the pillar projections (pillar 175) shown in FIG. 17, when vapor deposition is conducted to the pillars 175 from the direction of the arrow F3 and the direction of the arrow F4, the pillar 175 at the upstream side is shadowed, and additionally, the shadow region becomes asymmetric. For this reason, in each pillar 175, the inverted U-shaped aluminum vapor-deposited film can have different lengths between the left end and the right end.

Thus, an aluminum film of about 30 nm was formed on each pillar 175. The aluminum film functions as a catalyst to graphene to be film-formed next.

(Fifth Step)

A graphene film was formed on each pillar 175 by a CVD method using a mixed gas of methane, argon and hydrogen. Flow rate of each gas was methane: 27 SCCM, argon: 18 SCCM and hydrogen: 9 SCCM. Film formation pressure was 3 Pa, film formation temperature was 320° C., and film formation time was 200 seconds. Thus, the graphene film was formed on the aluminum film of each pillar 175.

(Sixth Step)

An epoxy resin-based UV photocurable resin (EXCEL-EPO, transparent type, manufactured by Cemedine Co., Ltd.) was applied in a thickness of about 30 μm to the pattern surface of the quartz glass substrate obtained, and a second quartz glass substrate having been subjected to waste liquid treatment was pressed thereon. The fluorine-based UV photocurable resin was cured with ultraviolet rays. The second quartz glass substrate was removed, and an assembly including the quartz glass substrate having the aluminum film and the graphene film, and the fluorine-based UV photocured resin was obtained.

(Seventh Step)

The assembly was dipped in a 5% hydrogen fluoride aqueous solution to selectively dissolve the quartz glass substrate and the aluminum film, thereby preparing a fluorine-based UV photocured resin (metamaterial) having concave pattern of the graphene film.

The above-described steps ((Fifth Step) to (Seventh Step)) were conducted using a sample comprising a flat quartz glass substrate of 20 mm×20 mm×0.5 mm and an aluminum film having thickness of about 30 nm which had been vapor-deposited thereon, thereby preparing a flat fluorine-based UV photocured resin (sample for measurement) having a flat graphene film.

Transmission and sheet resistance were measured using the sample for measurement.

As a result of the transmission measurement, the transmission of the sample at a wavelength of 400 nm was 70%, and the transmission of the sample at a wavelength of 800 nm was 80%. The sheet resistance was 10 kΩ/square. Those values are nearly the equivalent values of the results shown in the literature (Appln. Phys. Lett., 98, 091592, 2011), and it could be confirmed that the graphene film was properly formed by this method.

Particularly, it was confirmed that the metamaterial obtained by the above method has good transmission in a visible light region.

### Example 3

A metamaterial having electromagnetic wave resonators formed of graphene was produced by the following procedures.

(First Step)

A mold having a transfer pattern on a surface thereof, and a silicon substrate of 20 mm long×20 mm wide×0.5 thick were prepared. The same mold as used in Example 2 was used as the mold. However, the pattern of the mold was concavo-convex inverted pattern to the pattern shown in FIGS. 16(a) and 16(b).

(Second Step)

A fluorine-based UV curable resin (NIF-A-2, manufactured by Asahi Glass Co., Ltd.) was applied in a thickness of about 3 μm to the pattern surface of the mold, and the mold was pressed to a region of 5 mm×5 mm of the silicon substrate using a nanoimprint apparatus. After curing the fluorine-based UV photocurable resin, the mold was removed. As a result, projection structure was transferred to the silicon substrate. Unnecessary film attached to a bottom surface part of a pattern-formed surface of the silicon substrate was removed by an oxygen plasma ashing method, and only projections made of the cured resin were remained.

(Third Step)

Using SF₆ as an etching gas, the silicon substrate was subjected to etching by an RIE (Reactive Ionic Etching) apparatus using cured resin-made projections as a mask. The cured resin-made projections themselves are etched by the etching treatment. However, the etching rate is significantly small as compared with that of a part that does not have the cured resin-made projections on the surface of the silicon substrate. For this reason, on the surface of the silicon surface, the part that does not have the cured resin-made projections was etched deeper as compared with the cure resin-made projections. The etching was conducted until the cured resin-made projections were completely removed, and finally, a pattern composed of an arrangement of pillars of 100 mm long×100 mm wide×350 nm high was formed on the silicon substrate.

(Fourth Step)

Aluminum was vapor-deposited to the pattern surface of the silicon substrate in the same manner as in (Fourth Step) of Example 2. Specifically, first vapor deposition of aluminum was conducted such that an angle θ to a thickness direction of the silicon substrate is about 45°. Second vapor deposition of aluminum was conducted such that an angle θ to a thickness direction of the silicon substrate is about −60°. Thus, an aluminum film of about 30 nm was formed on each pillar. The aluminum film functions as a catalyst to graphene film to be formed next.

(Fifth Step)

A graphene film was formed on each pillar by a CVD method using a mixed gas of acetylene gas and argon. Film formation pressure was 1 kPa, and pressure of acetylene gas was 0.002 Pa. Film formation temperature was 650° C., and film formation time was 60 seconds. Thus, a graphene film was formed on the aluminum film of each pillar.

(Sixth Step)

A fluorine-based UV photocurable resin (NIF-A-2, manufactured by Asahi Glass Co., Ltd.) was applied in a thickness of 1 mm or more to the pattern surface of the silicon substrate obtained, and a quartz glass substrate having been subjected to waste liquid treatment was pressed thereon. The fluorine-based UV photocurable resin was cured with ultraviolet rays. The quartz glass substrate was removed, and an assembly including the silicon substrate having the aluminum film and the graphene film, and the fluorine-based UV photocured resin was obtained.

(Seventh Step)

The assembly was dipped in a 5% hydrogen fluoride aqueous solution to selectively dissolve the silicon substrate and the aluminum film, thereby preparing a fluorine-based UV photocured resin (metamaterial) having concave pattern of the graphene film.

Light absorption of the metamaterial prepared was measured.

When electromagnetic wave entered the metamaterial such that magnetic field penetrates through an electromagnetic wave resonator, resonance absorption was observed at a center wavelength of light of about 1,400 nm. Remarkable absorption of light was not observed in a visible light region of from 400 nm to 800 nm.

Thus, it was confirmed that the metamaterial obtained by the above method has good transmission in a visible light region.

### Example 4

A metamaterial having electromagnetic wave resonators formed of ITO was produced by the following procedures.

(First Step)

A mold having a transfer pattern on a surface thereof, and an aluminosilicate boroalkaline earth glass (EN-A1, manufactured by Asahi Glass Co., Ltd.) sheet (hereinafter referred to as a “glass sheet”) of 20 mm long×20 mm wide×0.1 mm thick were prepared. The same mold as used in Example 2 was used as the mold.

(Second Step)

A fluorine-based UV photocurable resin (NIF-A-2, manufactured by Asahi Glass Co., Ltd.) was applied to a pattern surface of the mold in a thickness of about 3 μm, and the mold was pressed to a region of 5 mm×5 mm of the glass sheet using a nanoimprint apparatus. After curing the fluorine-based UV photocurable resin, the mold was removed. As a result, projection structure was transferred to the glass sheet. Unnecessary film attached to a bottom surface part, of a pattern-formed surface of the glass sheet was removed by an oxygen plasma ashing method, and only cured resin-made projections were remained.

(Third Step)

A metallic nickel film was formed on the pattern surface of the glass sheet using a sputtering apparatus. The sputtering was carried out from a vertical direction to the pattern surface of the glass sheet. As a result, the metallic nickel film was formed on an upper surface of the projection and a projection-free surface of the glass sheet.

The glass sheet obtained was dipped in a potassium hydroxide aqueous solution, and the fluorine-based UV photocured resin was selectively removed by lift-off. As a result, a glass sheet in which, of the pattern surface of the glass sheet, a surface of a portion on which the projections had been present was exposed and other portion was formed by a nickel film was obtained.

Using SF₆ as an etching gas, etching was conducted to a nickel film-free part of the glass sheet using the nickel film as a mask by an RIE (Reactive Ionic Etching) apparatus. By the etching, pillar projection pattern of 100 nm long×100 nm wide×350 nm high, having the nickel film on the uppermost surface was formed. Thereafter, only the nickel film was removed using a 10N hydrochloric acid aqueous solution.

The pattern obtained in the glass sheet is the same pattern as the pattern of FIG. 17.

(Fourth Step)

ITO was vapor-deposited to a surface of the glass sheet from different two oblique directions. Thus, ITO was vapor-deposited in an inverted U-shape to each pillar.

ITO was formed by a magnetron sputtering method using a sintered ITO target (In₂O₃:SnO₂=90:10 (weight ratio)) as a target. Glass sheet temperature during film formation was 200° C. Atmosphere was a mixed gas atmosphere in which argon gas flow rate was 185 SCCM and water vapor flow rate was 0.4 SCCM, argon gas partial pressure was 0.4 Pa, and water vapor partial pressure was 3.4×10⁻³ Pa. Distance between the target and the glass sheet was 100 mm, distance between the target and a magnet was 40 mm, and power density during film formation was 7.0 W/cm².

Direction of vapor deposition of ITO is the same as in the case of vapor deposition of aluminum in (Fourth Step) of Example 2. Thickness of a vapor-deposited film of ITO was about 30 nm.

By the above steps, a metamaterial having ITO-made electromagnetic wave resonators formed therein was prepared on the glass sheet.

Although the embodiments of the present invention have been specifically described above, the present invention is not limited by those embodiments, and those embodiments can be modified, changed and/or combined without departing the gist and scope of the present invention.

While the invention has been described in detail and with reference to specific embodiments thereof, it will be apparent to one skilled in the art that various changes and modifications can be made therein without departing from the spirit and scope thereof.

This application is based on Japanese Patent Application No. 2011-284087 filed on Dec. 26, 2011, the entire subject matter of which is incorporated herein by reference.

The present invention can be used in a method for producing a metamaterial.

### DESCRIPTION OF REFERENCE NUMERALS AND SIGNS

11, 32, 61, 71: Support
12, 34, 42, 52, 63, 72, 83: Electromagnetic wave resonator
13, 35, 81: Metamaterial
15: Projection
16a: Upper part
16b: Side part
21: Apparatus for evaluating properties of resonance
22: Sample
23: Light source
24: Polarizing plate
25: Spectrophotometer
31: Apparatus for producing metamaterial
33, 41, 51: Material having adhesiveness
36: Pressure roller
43: Heater
53: Dielectric
62: Dielectric
73: Curable resin
74, 82: Cured product of resin
131: Conductor
132: Support
133: Unit cell
160: Mold
162: Pattern surface
165: Pillar
170: Quartz glass substrate
175: Pillar

What is claimed is:

1. A method for producing a metamaterial comprising an electromagnetic wave resonator resonating with an electromagnetic wave, the method comprising the steps of:
(a) forming a support by a nanoimprint method or a photolithography method, the support comprising a portion on which an electromagnetic wave resonator is to be formed, and
(b) vapor-depositing a material which can form the electromagnetic wave resonator on the portion of the support to thereby arrange the electromagnetic wave resonator on the support.

2. The method according to claim 1, wherein the step (b) comprises vapor-depositing the material which can form the electromagnetic wave resonator on the portion of the support by a physical vapor deposition.

3. The method according to claim 1, wherein the portion has one or two or more convex portions,
wherein the convex portion comprises a projection having an upper part and a side part, or side parts, and the upper part has a single flat surface, a plurality of surfaces having a difference in level, or a curved surface having a top,
wherein the step (b) comprises vapor-depositing the material which can form the electromagnetic wave resonator to the upper part of the projection and at least a part of the side part of the projection by vapor-depositing the material which can form the electromagnetic wave resonator to the portion of the support from a first direction.

4. The method according to claim 1, wherein the step (b) comprises vapor-depositing the material which can form the electromagnetic wave resonator to the portion of the support from two or more different directions.

5. The method according to claim 1, wherein the electromagnetic wave resonator is vapor-deposited to the portion in an approximate inverted U-shape upon viewing the support from a side direction thereof, and is vapor-deposited to the portion in an approximate C-shape upon viewing the support from a thickness direction thereof.

6. The method according to claim 1, wherein the material which can form the electromagnetic wave resonator is not vapor-deposited to a portion other than the portion of the support.

7. The method according to claim 1, wherein the support is composed of a material permeable to the electromagnetic wave.

8. The method according to claim 1, wherein the material which can form the electromagnetic wave resonator is at least one selected from the group consisting of graphene, indium-tin oxide, zinc oxide and tin oxide.

9. The method according to claim 1, wherein the step (b) comprises the steps of:
(b1) vapor-depositing a first dielectric to the portion of the support, and
(b2) vapor-depositing a conductive material and/or a second dielectric on the first dielectric after the step (b1).

10. The method according to claim 1, wherein the step (b) comprises the steps of:
(b3) vapor-depositing a metal film to the portion of the support,
(b4) vapor-depositing a graphene film on the metal film,
(b5) integrating the support having the graphene film with a second support such that a side of the graphene film faces inside, and
(b6) selectively removing the support and the metal film, thereby obtaining the second support having the graphene film.

11. The method according to claim 1, further comprising the steps of:
(c) selectively dissolving the support in a liquid, and
(d) forming a metamaterial in a state that the electromagnetic wave resonator is dispersed in a dielectric matrix.

12. The method according to claim 1, further comprising the step of:
(e) transferring the electromagnetic wave resonator arranged on the support to a material having adhesiveness.

13. The method according to claim 1, further comprising the step of:
(f) laminating the material having adhesiveness, which has the electromagnetic wave resonators transferred thereto, such that the electromagnetic wave resonators are piled up in a lamination direction.

14. A metamaterial comprising a support having a plurality of convex portions, and an electromagnetic wave resonator which resonates with an electromagnetic wave and is arranged on each convex portion,
wherein the each convex portion comprises a projection having an upper part and a side part, or side parts,
the upper part has a single flat surface, a plurality of surfaces having a difference in level, or a curved surface having a top,
a material which can form the electromagnetic wave resonator is vapor-deposited to the upper part of the projection and at least a part of the side part of the projection,
the electromagnetic wave resonator is formed in an approximate inverted U-shape having two end parts on each projection upon viewing the support from a side direction, and
a length from the upper part to one end part of the two end parts in a height direction is different from a length from the upper part to the other end part of the two end parts in the height direction.

15. The metamaterial according to claim 14, wherein at least two projections have a similarity shape each other, and
the respective electromagnetic wave resonators arranged on the at least two projections have substantially different dimensions while maintaining the similarity shape.

16. A metamaterial comprising a support having a plurality of concave portions, and an electromagnetic wave resonator which resonates with an electromagnetic wave and is arranged on the concave portion,
wherein the concave portion comprises a depression having a bottom part and a side part, or side parts,
the bottom part has a single flat surface, a plurality of surfaces having a difference in level, or a curved surface having a top,
the material which can form the electromagnetic wave resonator is vapor-deposited to the bottom part of the depression and at least a part of the side part of the depression,
the electromagnetic wave resonator is formed in an approximate U-shape having two end parts on each depression upon viewing the support from a side direction, and
a length from the bottom part to one end part of the two end parts in a height direction is different from a length from the bottom part to the other end part of the two end parts in the height direction.

17. The metamaterial according to claim 16,
wherein at least two depressions have similarity shape each other, and
the respective electromagnetic wave resonators arranged on the at least two depressions have substantially different dimensions while maintaining the similarity shape.

18. The metamaterial according to claim 16, wherein the electromagnetic wave resonator is not formed on a portion other than the depression of the support.

19. The metamaterial according to claim 16, wherein the electromagnetic wave resonator is composed of a conductive substance through which an electromagnetic wave in a visible band transmits.

20. The metamaterial according to claim 19, wherein the electromagnetic wave resonator is at lest one selected from the group consisting of graphene, indium-tin oxide, zinc oxide, tin oxide and metal.
